(19) United States
(12) Patent Application Publication
(10) Pub. No.: US 2011/0082850 A1
(43) Pub. Date: Apr. 7, 2011

(54) NETWORK RESOURCE INTERACTION DETECTION SYSTEMS AND METHODS

(75) Inventors: Derek BALL, Calgary (CA); Dayton Foster, Calgary (CA); R. Allan MacKenzie, Calgary (CA)

(73) Assignee: Tynt Multimedia Inc., Calgary (CA)

(21) Appl. No.: 12/898,637

(22) Filed: Oct. 5, 2010

Related U.S. Application Data
(63) Continuation-in-part of application No. 12/683,375, filed on Jan. 6, 2010.
(60) Provisional application No. 61/272,550, filed on Oct. 5, 2009.
(60) Provisional application No. 61/272,685, filed on Oct. 21, 2009.
(60) Provisional application No. 61/272,972, filed on Nov. 27, 2009.
(60) Provisional application No. 61/288,804, filed on Dec. 21, 2009.
(60) Provisional application No. 61/342,870, filed on Apr. 19, 2010.
(60) Provisional application No. 61/282,942, filed on Apr. 27, 2010.
(60) Provisional application No. 61/344,028, filed on May 10, 2010.

(51) Int. Cl. G06F 17/30

(52) U.S. Cl. 707/706; 707/769; 707/728; 707/E17.108

(57) ABSTRACT

Systems and methods are described for intercepting user interactions without network-provided content. The intercepted information can be used for prioritizing search results by statistical and other analyses of user interactions with a network resource and/or network content. A server connected to a network can receive captured information from an agent that is installed in a device connected to the network. The captured information can be related to an interaction of a user with a network resource. An aggregator may be provided to aggregate the captured information with other captured information related to a plurality of network resources and maintains a repository of aggregated captured information. A prioritizer can determine the relevance of network content based on characteristics of the aggregated captured information. The prioritizer determines relevance for a plurality of search results based on frequency of prior user interactions with the content of the search results.

### CROSS-REFERENCE TO RELATED APPLICATIONS

The present application is a continuation-in-part of U.S. patent application Ser. No. 12/683,375, filed Jan. 6, 2010 and claims priority from U.S. Provisional Patent Application No. 61/272,550, filed Oct. 5, 2009, from U.S. Provisional Patent Application No. 61/272,972, filed Nov. 24, 2009, from Provisional Patent Application No. 61/288,804, filed Dec. 21, 2009, from Provisional Patent Application No. 61/342,870, filed Apr. 7, 2010, from Provisional Patent Application No. 61/282,942, filed Apr. 27, 2010, from Provisional Patent Application No. 61/344,028, filed May 6, 2010 and from Provisional Patent Application No. 61/272,685, filed Oct. 21, 2009, which applications are expressly incorporated by reference herein for all purposes.

### BACKGROUND OF THE INVENTION

1. Field of the Invention

The present invention relates generally to data transfer between computer resources and more particularly to data transfer between computer systems that communicate by means of a network.

2. Description of Related Art

All publications, patents and patent applications cited within this application are herein incorporated by reference in their entirety to the same extent as if the disclosure of each individual publication, patent application or patent was specifically and individually indicated to be incorporated by reference in its entirety.

In recent years the popularity of computers, and the communication networks established between these computers, have increased dramatically. Such networks allow computer users, either in a business, government or personal setting, to communicate with each other, either through a centralized communication point, through a plurality of distributed and redundant communication points, or directly. This allows exchange of information between the computers on the communication network, using a common communication protocol between them. It is common for corporations or business to establish a common communications network between their computers, otherwise referred to as “intranets”, in which the communication network has limited or no access to unauthorized persons and/or computers. It is common for intranets to be protected by security systems, such as firewalls, which prevent access by unauthorized users of the communications network, the computers communicating through it, and the information contained within these computers.

The term “Internet” has been adopted to describe the publicly available network which has nearly worldwide coverage, and to which most personal computers have access. The pervasive nature of the Internet, combined with the lower cost and increased performance of personal computers, has led to it being a popular source of information. Systems are available which provide an individual with the ability to search for information or resources within the Internet. For example, systems exist which allow a user to search for information stored on other Internet computers (i.e., servers), thus providing generalized access to these resources. Unfortunately, when an individual is searching for specific information, the resource on the Internet may not provide the specific information desired by the individual, or else it may provide certain information in an undesired context. The individual may then continue searching, or else use an alternate system to perform the required searching activities. In general, these searching systems provide minimal ability for a user to provide feedback as to the success of the search, or ways for the user to refine future searches. Generally, the user establishes a series of search terms to initiate a search, and upon failure of the search results to provide the user with what he is looking for, the user modifies or adds further search terms in an effort to increase the chance of success on the next search. Alternatively, the user may switch to an alternate search system and attempt to obtain a successful search result using that second system.

Computers communicate within a network using a common set of standards for exchanging data. One common example is the Transmission Control Protocol/Internet Protocol (TCP/IP) suite. To initiate communications within the communication network, a user (client) may contact another computer on the network (server) and request information or a resource. This is facilitated by various software and hardware systems generally available. A user can access resources within the Internet by being directed through software (e.g., by clicking a hyperlink), by entering a Universal Resource Locator (URL), etc.

A popular protocol for organizing and sharing information on the Internet via the client/server model is known as the HyperText Transfer Protocol (HTTP), and is more commonly referred to in a general sense as the World Wide Web (the web). Generally, the web links information by associating items of interest through the use of HyperText Markup Language (HTML) files, which reside on servers and usually are transferred to clients via HTTP. A user of the web may traverse it by receiving and viewing an HTML file (or just an image, video, etc.), which may contain within it information or embedded images, but which also may contain information on how to acquire further resources from the web, by, for example, incorporating URLs within the file. This information may be displayed to a user as a combination of text and media (for example images, sound, video) and generally is referred to as a “page” or “web page.” Generally, the user uses a client, called a web browser, to interact with the web and the various files found on it (e.g., HTML, audio and video files, etc.).

No central authority exists for cataloguing the hundreds of millions of network resources, such as HTML pages, files or media available within an intranet or the Internet. In general though, there are two approaches taken for finding information or resources of interest within a network: 1) a directory hierarchy and 2) a search engine.

Within a directory hierarchy a web page may be analyzed and categorized, allowing users to scan through various categories, and associated subcategories, to identify resources of interest. Alternatively, a search engine may provide a dataset of terms and phrases (keywords) upon which a user may query, and may return a listing of web resources associated with the keywords. Many such search engines are known in the art, with examples including, but not limited to, Google®, Yahoo® and Alta Vista®

A search engine generally includes two main parts: an index searcher and an index generator. An index searcher may include a database of indexing keywords of web pages and logic for searching the database. An index generator may include a “spider” for gathering web pages and an “indexer” for generating an index into those pages. Typically, a search engine works by sending out the spider to fetch web pages (by, for example, following the various links that exist on an initial set of web pages). The indexer may then read these pages and create an index based on the words contained in each page. Search engines typically use a proprietary algorithm to create their indices such that, ideally, only meaningful results are returned for each query. Provided with a page by a spider, an indexer may parse the document and insert selected keywords into the database with references back to the original location of the source page. How this is accomplished depends on the indexer. Some indexers index the titles of the web pages or just the first few paragraphs. Some parse the entire contents and index all words. Some parse available meta-tags or other special hidden tags. Meta-tags are special HTML tags that are meant to provide information about a web page. Unlike normal HTML tags, meta-tags do not affect how the page is displayed. Instead, they provide information such as who created the page, how often it is updated, what the page is about, and which keywords represent the page's content. Many search engines use this information when building their indices.

A common problem for these search engines is that they are, by necessity, automated. As such, the vagaries of human language may result in search results that are not always relevant to the query. For example, searching upon the keywords of “Miami” and “dolphins” may return web resources relevant to both a professional football team based in Florida, as well as aquatic mammals on display within the Miami locale. Further, automated search engines generally are poorly constructed to translate the context of web resources into a form searchable by keywords. For example, if searching for information regarding a consumer product, you are likely to receive web resources related to an individual consumer's experience with the product in addition to web resources which enable one to purchase the product. Finally, the relevance of any given web resource returned in response to a search engine query may be based upon a multitude of different factors, such as the number of web pages which refer to a given web resource, the number of times a given keyword appears within the text of a web resource, whether a person or corporation has paid the provider of the search engine to receive more favorable treatment, etc. Therefore significant effort may be required of the user in order to obtain relevant and preferred information via a search engine.

Furthermore, the Internet has voluminous resources and information sources available to it, yet the ability for an individual user to communicate or interact with a web resource generally is limited to that which the creator of the web resource allows. A user is limited in his ability to share or direct persons with whom he knows or shares a common interest; generally, he may either post a reference to the web resource on another web resource accessed by the persons he knows or accessed by those with whom he shares a common interest, or pass the URL to specific users or computers by direct communication, such as by electronic mail.

A common problem for publishers of web pages or creators of network resources is that there is a benefit to keeping users within a given web site, or within a collection of web sites under common ownership; generally this is driven by the acquiring of revenue through advertising presented in conjunction with the content present in the network resource. Therefore it is desirable for a web publisher to attempt to deter a user from leaving a particular web site, or collection of web sites; and instead direct the user to a resource within the given web site or a collection of web sites.

A further issue for those providing content within a network, or those who are reviewing content available on a network, is using network content to derive information on trends within a region, culture, geographical location, country or the world in general. The addition of content, or changes to the search terms used by a population, may represent a change in thought, or increased interest in a population on certain issues, information or opinions. This is highly relevant and valuable information and there are advantages for parties who are able to quickly identify trends or changes to a population's interests, thoughts or opinions.

Many of the computers used today are capable of multi-tasking, and further provide a variety of user interfaces for controlling various and multiple application programs or system functions simultaneously operating in the computer environment. Personal Computers (“PC”) are particularly commonplace, operating with an operating system (“OS”) capable of multi-tasking such as Microsoft Windows™ or Apple Computer's MacOS™, or LINUX™. Smaller computing platforms such as held-held computers, personal digital assistants (“PDA”), and advanced wireless telephones may run operating systems capable of multitasking as well.

Users often wish to copy or transfer information or “content” from one program or system function within an OS environment, to another. Using “copy and paste” functions of the application programs and the operating system, the user may select information from a source program (e.g. a Web Browser receiving and displaying information received over an Internet), and “paste” it into the destination program (e.g. a text editing program or document creation program). The copy and paste process is described more fully in U.S. patent application Ser. No. 12/192,391, hereby incorporated herein by reference, in its entirety, including figures, to the present patent application.

With respect to the accessing of information through a network, for example an Internet, it is a problem in the present state of the art that people who publish content (text, images, audio, etc.) accessible within a network can easily have their content copied without their knowledge or authorization. The very functionality of the copy and paste within an OS make this easy in the digital world. Industry observers sometimes refer to this as ‘atomization’ of content.

Tools exist to help content publishers find when their content has been copied and posted on other websites or blogs, however, no tools exist to help content owners learn who is using simple cut and paste functions to copy data from their website within their PC, into products such as e-mail, Microsoft Word™, PowerPoint™ or other programs or system functions. It is currently impossible for publishers to monitor this cutting and pasting process because they have no ability to include attribution with the copied content. With monitoring and tracking, it is possible that publishers of content may be better able to monetize the copying and usage of their published content.

There is a significant interest for those parties making content available on a network, such as an Internet, to provide opportunities for persons accessing a network resource to purchase goods or services as a follow-on action. It is a reasonable assumption that parties accessing a network resource with content relating to a particular topic will be amenable to purchasing goods or services directly or indirectly related to that topic. Therefore advertising is often displayed in association with a network resource generally made available to the public, the advertising displayed selected based upon the content of the network resource, the referral link of the accessing party, the past history of accessing network resources of the party (using, by way of non-limiting example, “cookies” as are known in the art) and combinations thereof, as currently known in the art. This has been further refined in the current art wherein individual words or phrases within the content of the network resource are identified to the party accessing the network resource as differentiated from the majority of the text, so as to entice the party accessing the network resource to “click” or otherwise elect to be transferred from the network resource to another.

It is commonplace that a user is directed to a “landing page” as it is known in the art, or a network resource that presents content which is a logical extension of the advertisement, differentiated word or phrase, or search engine search result. Such landing pages may be static, in that the information presented is the same for all users until modified by a human or automated means; or dynamic, in that the landing page is generated through automated means immediately preceding or contemporaneous with a user accessing the landing page. Dynamic web pages may utilize the referral link driving the user to the landing page, past history of network resource access of the user, geographic location, computer system information, or any other information obtainable on the user in order to generate the landing page. See for example United States Patent Application Pub. Nos. 20100042635, 20080027812, 20040044566, 20080040389, 20080091526 and U.S. Pat. Nos. 7,281,042 and 7,523,087, which are herein incorporated by reference, in their entirety.

### BRIEF SUMMARY OF THE INVENTION

Certain embodiments of the invention provide systems and methods for processing user interactions with content obtained from a network. The method can be performed by one or more processors communicatively coupled to the network and typically comprises detecting an implicit user interaction with an element of the content on a device that displays the content, wherein the implicit user interaction includes a copy interaction, a selection interaction and/or a mouse over interaction, where the mouse over interaction comprises using a mouse or other oral or tactile pointing device to place a mouse over the element. The method typically comprises the additional steps of extracting at least one search term from the element and displaying one or more selected links on the display device. The one or more links can be selected based on the at least one search term and may be displayed simultaneously with the content. The one or more links can be displayed in a pop-up window on the display device and the at least one search term may comprises a plurality of search terms. The one or more links may include results of a search based on the search terms and the results can be prioritized based on a history of implicit interactions with the element. A relevance of the element may be calculated based on the history of implicit interactions with the element and the results can be prioritized based on the relevance of the element. The method may also comprise the step of performing a search using the search terms and the selected links typically include at least one result of the search. Implicit user interactions can also include printing and/or sharing the element.

Certain embodiments of the invention provide an agent adapted for use in a browser installed and/or executed on a computer system. Typically, the agent comprises data and instructions that, when executed by a processor of the computer, cause the computer to perform a method for detecting and processing user interactions as described herein. The user interactions may be implicit interactions with an element of content displayed by the browser including mouse over interactions, selecting, copying, printing and/or sharing of the element. The element may include text and/or graphics. Detection of interactions may be limited to elements having a minimum and/or maximum size. In certain embodiments of the invention, the agent is transmitted to a computer system or other processing device that hosts a browser or otherwise displays network content. The agent may be transmitted attached to and/or embedded in content accessed by the browser.

### BRIEF DESCRIPTION OF THE DRAWINGS

FIG. 1 shows a schematic of a communications flow for a user computer running user interaction detection client software, a RUII server and a network resource (for example, a web page) wherein the user computer is accessing a network resource via a network according to certain aspects of the invention.

FIG. 2 shows one example of delivering user interaction detection software to the user computer according to certain aspects of the invention.

FIG. 3 shows a schematic of the communications flow between the Network Resource Provider (for example, web page) the user client software (Client Browser) and the RUII server upon accessing a network resource according to certain aspects of the invention.

FIG. 4 shows a schematic of the communications flow for increasing the relevance of search results RUIIs according to certain aspects of the invention.

FIG. 5A is a schematic showing details of the communications flow for increasing the relevance of search results using RUIIs according to certain aspects of the invention.

FIG. 5B is a flowchart of an example of implicit interaction automated searching according to certain aspects of the invention.

FIG. 6 is a schematic showing details of communications flow for increasing the relevance of search results using RUIIs according to certain aspects of the invention.

FIG. 7 is a simplified block schematic illustrating a processing system employed in certain embodiments of the invention.

FIGS. 8A-8C show examples of power-law distribution.

FIG. 9 is a process flow employed in one embodiment of the invention.

FIGS. 10, 11A, 11B, 12A and 12B are screenshots obtained from one embodiment of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. For example, the descriptions below refer to a interactions between computers and it will be appreciated that the term computer can be taken to mean any suitable computing device such as servers, desktop computers, laptop computers, intelligent user devices such as cell-phones, PDAs, set-top boxes, game players and smart phones, etc. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the present invention provide systems and methods for detecting user interactions with network resources accessible within an electronic network. Furthermore, systems and methods are provided for increasing, or decreasing, the relevance of network resources comprising the results of a search through monitoring of user interactions with network resources.

Certain embodiments of the present invention are broadly applicable to a variety of systems and are not limited to any particular programming language. For the purposes of this discussion only, descriptions will generally refer to embodiments of the invention using the JavaScript™ programming language, which is highly prevalent in many commercially available Internet browsers. In one embodiment, for example, a system comprises combinations of hardware and software. Software code is typically communicated proximate in time with, or concurrent with, the communication to a second computer of a network resource located on a first computer. For example, a web page may facilitate this communication whereby the code contains one or more functions according to certain aspects of the invention (described in more detail below); the network resource can comprise digital content of various types.

In certain embodiments of the invention, information comprising software code is communicated proximate in time, or concurrent with, the communication to a second computer of a network resource located on a first computer. Software code may be understood as including instructions and data interpretable by a computing system with a suitable combination of applications, operating systems, interpreters, compilers and/or dynamic linkers. For the purposes of this description, software code that is transferred as described herein can be referred to as an agent. In one example, a web page may be transmitted to a device capable of processing and displaying the web page. The code typically comprises instructions that cause a processor to perform one or more functions as will be described herein. The network resource may comprise digital content provided through a web page.

In certain embodiments, the code can be executed proximate in time to the provision of a display based on, and/or including the network resource on the first computer. The display may be provided using a viewing program capable of viewing the network resource including, for example, a web browser. The execution of the code can provide a copy command intercept program operating on the first computer that is capable of interacting with the viewing program. The copy command intercept program is typically configured to alter the normal process of copy command application within at least the viewing program.

Various search and retrieval techniques can be employed to make the search and retrieval process more deterministic or efficient. For example, in the field of web resource retrieval, a vocabulary for describing web resources, or documents, may be used, typically according to characteristics of the language itself. Such a system may operate much like an index of a book. For example, a description language may be derived based upon the frequency of occurrence of various words in the language and the juxtaposition statistics of these words (i.e., which words tend to appear together) within the web resource or document. This description language may then used to group various documents and to later retrieve them.

One example of a search technique employs a keyword search that utilizes an index of keywords from an eligible listing. Another example comprises a network that maintains collections of documents and uses an arbitrary set of words to characterize each document in the collection. When a user subsequently requests the retrieval of particular documents, the user may guess at what terms were used in the classification process, or instead may be presented with a fixed list, such as a list of categories. For example, a user might request the system to locate all documents having to do with “balloons”. The success of the search in this instance may be directly dependent on how many and which documents had been associated by the search system with the word “balloon”. Since the choice of the words used by the system to characterize the documents may be, and likely is arbitrary, the user's rate of success at picking the same words to describe the same document may be somewhat random.

Generally, conventional keyword searches suffer from missing relevant documents or the retrieval of irrelevant documents, referred to as errors arising from “semantic mistyping.” Since words can be used in variant senses, a document can satisfy a query perfectly well when using a keyword-matching method, but the words in the keyword listing (or even within the network resource itself) may be used in a different sense than those used in the search query from which the search results are generated. Thus, semantic mistyping may lead to a poor user experience by decreasing the availability of relevant documents. Further, since words in languages may have multiple meanings, the possibility of erroneous search results is not insignificant.

One method for mitigating errors attributable to semantic mistyping is to increase the relative ranking of network resources which are more “popular,” with popularity determined through, for example, the frequency of a network resource being selected by a user in prior search results, the frequency of a network resource being selected by the search engine to be included in the search results, the number of references to the network resource present within a network (i.e. number of network resources linking to the particular network resource), etc. In the case where two network resources are otherwise equal with regard to their appropriateness as a search result, the one with the higher rank may appear before (or instead of, etc.) the one with the lower rank.

Increasing the rank of a network resource within a list of search results based upon the popularity of the network resource does not necessarily correlate with increasing the relevance of the network resource, and such behavior has aspects of a self-reinforcing system. For example, the presence of an irrelevant network resource within a list of search results may result in a user accessing the irrelevant network resource for a period of time sufficient for the user to realize that it is not relevant. The user may then select another network resource within the list of search results, and on this second attempt the network resource may be relevant. In such a situation, the search system has difficulty in identifying that the first network resource was not relevant, while identifying the second as relevant: i.e. both received a “click-through” and therefore may be considered equally relevant by the search engine. As such, many conventional search systems have difficulty identifying the relevance of network resources, this difficulty arising partially from the inherent vagaries of human language and the inherent weaknesses of search methodologies (such as keyword-based searches).

A copy command intercept program can be configured to alter the normal process of copy command application within at least the viewing program. Upon selection of a copy command by the user (a “copy event”) the copy command intercept program causes elements selected for copying to be transmitted into the user's copy/paste memory buffer of the second computer with additional content appended into the memory buffer such additional content being defined by a manager or administrator of the first computer. Optionally, the copy command intercept program reports copy events to at least one other computer in network communication with the second computer, and the copy event information may be stored in a database for analysis. The copy event information typically comprises identification of the copied content (and/or the copied content itself), the URL of the original article, the IP address/geographic location of the browser performing the copying, and/or other information generally known in the art as useful for identifying relevance of information to a user. This information is then used by the web page manager/administrator to better understand which network resources, or elements within a particular network resource are popular, frequently copied or of increased relevance to the user.

In certain embodiments, the additional content will be pasted with content selected by the user, typically when the user causes the content to be the subject of a copy event. Statistics can be generated for the web site manager/administrator for a variety of purposes, including:
a. Help with attribution of content
b. Better understand which elements of a network resource are interacted with by a user and how often
c. Correlate user interactions with frequency of access of network resources.

In certain embodiments of the present invention, software code is communicated to a second computer proximate in time, or concurrent with, the communication to the second computer of a network resource located on a first computer. The network resource may include, for example, a web page and the code can include instructions that cause a computer to perform at least some of the functions provided according to certain aspects of the invention and described in more detail below. The network resource typically comprises digital content. Code can be executed proximate in time to the network resource display on the first computer using a viewing program capable of viewing a network resource, such as a web browser. As a result, a detection computer program operating on the first computer is capable of interacting with the viewing program, whereby the detection program can identify user interactions with a network resource by means of a user interaction detection program.

When the user interacts with the network resource, the user interaction identification program typically causes the communication—from the second computer to the first computer, and/or to a third computer—of the occurrence of a user interaction with the network resource. Additional information may be communicated including information identifying the URL of the network resource, the internet address of the second computer, the time of user interaction with the network resource or elements within the network resource that are subject of the interaction. A user interaction with the network resource can include the copying of, the selection of and/or the printing of certain elements forming part of the network resource and/or can include the copying of the URL of the network resource.

The user interaction communicated to the first computer, or to a third computer, may be stored in a database for analysis. This information can then be used by the web page manager/administrator to better understand which content is popular, which is frequently copied and/or which content is of increased relevance to the user. In some embodiments, statistics are generated for the web site manager/administrator to:
a. help with attribution of content,
b. better understand which elements of a network resource are interacted with by a user and how often, and
c. correlate user interactions with frequency or access of network resources.

According to certain aspects of the invention, the interaction of a user with a webpage can include the copying of, selection of and/or printing of certain elements forming part of the network resource. The interaction of a user with a webpage can also include copying the URL of said network resource. As used herein “selection of” with respect to certain elements forming part of a network resource means a user interaction with a network resource such that a portion of said network resource is displayed differently to a user than the remainder. For example, programs capable of viewing a network resource, such as internet browsers, allow the selection of text by the user which results in the modification of the display of the text to the user. In one example colors of the text and its surrounding area may be inverted (e.g. white to black, black to white, etc.).

The detection of the copying of an URL may be implemented by various means. Typically, detection of copy events outside of the program environment of the network resource viewer (hereinafter “browser”) requires implementation within the operating system of the user computer. Though possible, this presents a number of challenges, including interception of such programs by virus detection and protection software. In some embodiments, an ID can be uniquely generated on each access of the network resource by a user and inserted in the URL of a network resource which includes the user interaction detection software. Insertion can be made without otherwise interfering with accessing of the network resource by browsers and other programs. The URL which includes the uniquely generated ID can be detected by the computer hosting the network resource if the URL is used at some later time, and can then be correlated with a past access. Thus, the act of copying of an URL is not monitored, but the act of a user utilizing a copied URL is registered. It is contemplated as part of the present invention that the uniquely generated URLs may include as part of the URL an encoded measure of the time of the unique URL generation or the internet address of the user accessing the network resource. Such means of encoding are known in the art, using a reversible function, for example. It is contemplated in the alternative, that a database of unique URLs may be maintained, where the URLs are correlated to an encoded measure of the time of the unique URL generation or the internet address of the user accessing the network resource.

User experience can be appreciated by considering an embodiment that involves a first user accessing a network resource using a network, such as the Internet, a second user and a network resource administrator (e.g. a website administrator) who receives information on the content viewed and/or copied by the first user. In the example, the first user initiates a copy-event when, for example, deciding to copy some content a network resource such as a web page. The user selects the content and uses the copy function of the computer or mobile device. The copy function may involve selecting a combination of keyboard keys, (<Ctrl C> or <Apple> C, for example) and/or may be initiated by selecting an option from a menu (e.g. right click and selects ‘copy’ command, chooses Copy from a main menu, etc). The user then pastes the content into a document in a word processing, email, note pad, or other application or tool. The originally selected content is then typically pasted and may optionally be augmented with additional information as specified by the owner of the site from which the copy is made. This additional information can include, for example, a link back to the original article, attribution text and so on. An example of this might be:

[Content for which Copying is Requested]
South Africa's problems, along with other factors like rising crime and relatively low pay, are pushing many physicians out. Some, like Dr. Craig Laurence, feel Canada's pull. In March, Laurence

### [Additional Information]

Click here to read the original article at http://www.calgaryherald.com/Alberta+bound+South+African+doctors+coming+Canada/1063582/story.html#ixzz0QvJ417Nx
The Calgary Herald—Calgary's Best Source For News!

In this example, the additional information element ‘#ixzz0QvJ417Nx’ represents a unique identifier (‘ID”) generated when the content is copied and which may be combined with the program of the present invention operating on the user computer and which can allow the highlighting of copied content when the URL present in the additional information is accessed. This is typically enabled by way of communication of the unique generated ID by the program of the present invention operating on a user computer, to a computer in network communication with it, wherein:
an agent/program according to certain aspects of the invention, which operates on a user computer, communicates the unique ID to a second computer in network communication with it;
the second computer, which had received and stored the unique generated ID along with the content copied by the first user when the first user undertook the copy action, retrieves the content copied by the first user and communicates this to the second computer;
the agent/program causes a user computer to then modify the network resource displayed to the second user such that the original content copied by the first user is identified by, for example, highlighting the originally copied content; and
the agent/program of the present invention may cause the user computer to receive that information and then apply a highlighting or other format change to that element using the uniquely generated ID to identify which portion of the network resource was originally copied (such event generating the unique ID).

Continuing with the example, a second user uses the link optionally included in the additional information. Activating or otherwise using the link may cause web page to load with the copied content highlighted to allow the user to view the context. A web site manager/administrator for the site which provided the network resource, or other party interested in user interactions with the network resource may be informed directly by electronic communication of the existence of an interaction with the network resource. The collection, summarizing and electronic communication of a multiplicity of user interactions may be automated for access by a web site manager/administrator at some later time. Such data may comprise:
a. The number of times elements within the network resource are copied
b. The most copied elements within a web page
c. The number of times links generated as a result of appending information as part of a copy-event are then viewed by the same or different user as distinguished by their IP address
d. The geographic location of the user who undertook the copy-event
e. A “tag cloud” of most commonly copied elements in a time period

According to certain aspects of the invention, the means of measuring relevance by other search engines, such as Google, may be indirectly benefited. Many search engines rely heavily on the number of reference links to a particular web page to calculate relevance of the particular web page in search results. That is, a web page that has a high number of sites referring or “linking” to it will appear higher in the search results. When interactions with elements within a web page or the URL of a web page occur, or when the page or URL is copied and pasted into a document that is not generally available within the network, the network resource subject to the user interaction or copying event loses the benefit of links back to their site capable of being identified by such search engines. Therefore, in certain embodiments, the act of interacting with a network resource can result in an automated publishing of the network resource URL in a form that it is available to the search engine as part of the communication from the user computer to another computer in network communication with the user computer. This feature permits a search engine to recognize user interaction with a network resource and thereby increase the quality of its searches.

Certain embodiments of the invention provide a method by which user interactions with an element within a network resource present in a network provides certain contextual and relevancy information with respect to the resource. User interactions can include, for example, copying, selecting or printing certain elements that form part of a network resource and/or copying the URL of the network resource. Network resources receiving a large number of user interactions by a multiplicity of users may be considered to contain information more relevant than other network resources with less user interactions. Alternatively, the presence of certain keywords within the elements with which a user interacts may be used to derive the context of the underlying network resource. Therefore the user interactions may be collectively utilized to increase the relevance of a resource present within a network when determining search results for a query. Certain aspects of the invention may be equally applicable to various networks including the Internet, intranets and local area networks.

In one example, the presence of specific keywords (e.g., “excellent”, “good”, “great”, “bought,” etc.) in text elements interacted with in a network resource (such as a web page) intended for on-line shopping, may be used to increase the relevance of the particular resource within an index of network resources. Various additional means of searching and/or indexing network resources are contemplated within the scope of the present invention; the relevance of network resources may be compared to other network resources which would be identified by a similar search or indexing method. Therefore, the utility of such analysis of the content of elements in a network resource and subject to a user interaction using presently disclosed systems and methods is applicable regardless of the underlying search system upon which the user interactions provide relevance information.

One skilled in the art will recognize that the content of the elements within a network resource subject to a user interaction can add additional information which may be utilized to obtain information with respect to the relevance of the underlying network resource, the context of the underlying network resource and/or other semantic information. In addition, the occurrence of a user interaction itself with respect to a network resource may provide relevant and useful information with respect to the underlying network resource, especially relative to other network resources that have received no user interactions. In one embodiment of the present invention, the number of user interactions with respect to a network resource may be utilized to increase the relevance of a given network resource among multiple search results.

In certain embodiments of the invention, the frequency of user interactions can be used to increase the relevance of a given network resource among multiple search results. The frequency of user interactions may be used to express the number of user interactions with a network resource over a given period of time, the number of users interacting with a network resource relative to the total number of users interacting with all monitored network resources or subset thereof and/or the number of user interactions with a network resource within a period of time relative to the total number of user interactions with all monitored network resources or a subset thereof within the same period of time.

The present invention is not limited to implementation with a particular network resource user interaction detection system. In one example, a detection system capable of identifying and communicating user interactions with a network resource maintains information related to the occurrence of an interaction, content associated with an interaction and/or particular terms contained within any text elements related to an interaction as part of the user interaction detection (Relevant User Interaction Information or “RUII”) separate from the user computer. Typically, at least one computer acts as a central server. The central server may receive a query from a client program executed by a user computer, wherein the query may contain, at a minimum, the URL of the network resource being viewed on the user computer. The central server may then respond to the query as to whether there exist RUII associated with the URL of the network resource. The benefits of this particular structure, in particular with the method and system for increasing relevance of search results within a network, is the ability to collate, collect and/or scan RUII from a multiplicity of users with at least one computer acting as a centralized service provider.

It is contemplated that the present method and system for increasing relevance of search results within a network may be implemented with other user interaction detection systems. For example, those user interaction detection systems based upon storage of user interaction information for network resources in a distributed manner including, for example, when the user interaction information for network resources for a given user is maintained within that user's computer or immediate computer network. In such a case, it may be necessary to query the distributed user interaction detection systems for the existence of RUII associated with a particular network resource (by use of, for example, a URL) as well as other information. In some embodiments, the user interaction detection systems may be queried for solely the existence RUII. In one embodiment employing a distributed user interaction detection system, the distributed systems may be queried on an intermittent basis, with the results collected and maintained at a central results server. A protocol may be employed that reduces query time upon receipt of search results (i.e., the time needed to determine whether any user interactions are associated with network resources identified with the search results), avoiding the requirement to query a multiplicity of distributed user interaction detection systems each time search results are received.

In one embodiment, the user interaction detection system is based upon a RUII server in network communication with a user computer, whereby the RUII server receives RUII from a client software application running on the user's computer. The system may store the RUII of a user and may optionally store the RUII together with formatting information which may localize the user interaction within the network resource, on a RUII server separate from the web server hosting the network resource.

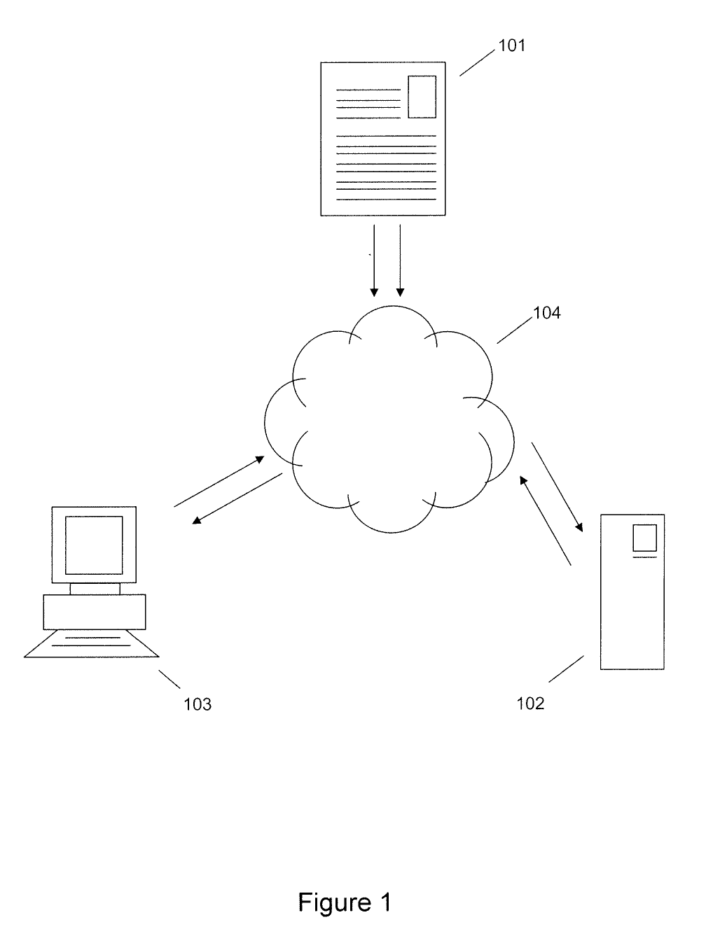

FIG. 1 shows a simplified schematic of one embodiment of the invention that illustrates the relationship between a user computer 103 and RUII server 102. User computer 103 is performs the function of user interaction detection client, typically by executing instructions and interacted with data maintained by computer 103. A portion of a network resource 101, such as a web page, is subject to user interaction by the user on user computer 103. In certain embodiments, user interacts with one or more network resources that may include, for example, application-specific documents, video content, audio content and/or databases. The communication between user computer 101, RUII server 102 and network resource 101 may be accomplished using one or more networks 104. The network may be private or public, local or external and may be a part of a larger network such as the Internet. The RUII server 102 typically communicates with user computer 103 using a client provided on user computer 103, where the client is in network communication with RUII server 102. The client may be implemented using any combination of hardware and software appropriate for the computing device that serves as user computer 103.

In certain embodiments, user interaction detection software may be provided on user computer 103, and can operate in conjunction with a program and/or in an environment within a program capable of accessing, displaying network resources as well as interpreting and effecting computer-readable instructions. Computer readable instruction may include instructions written in Java®, JavaScript and/or programming instruction languages corresponding to a certain web browser, applet, etc. The user interaction detection software may be preinstalled such that the software is normally resident upon the computer and is available to the user upon each use of the software capable of accessing or displaying a user network resource.

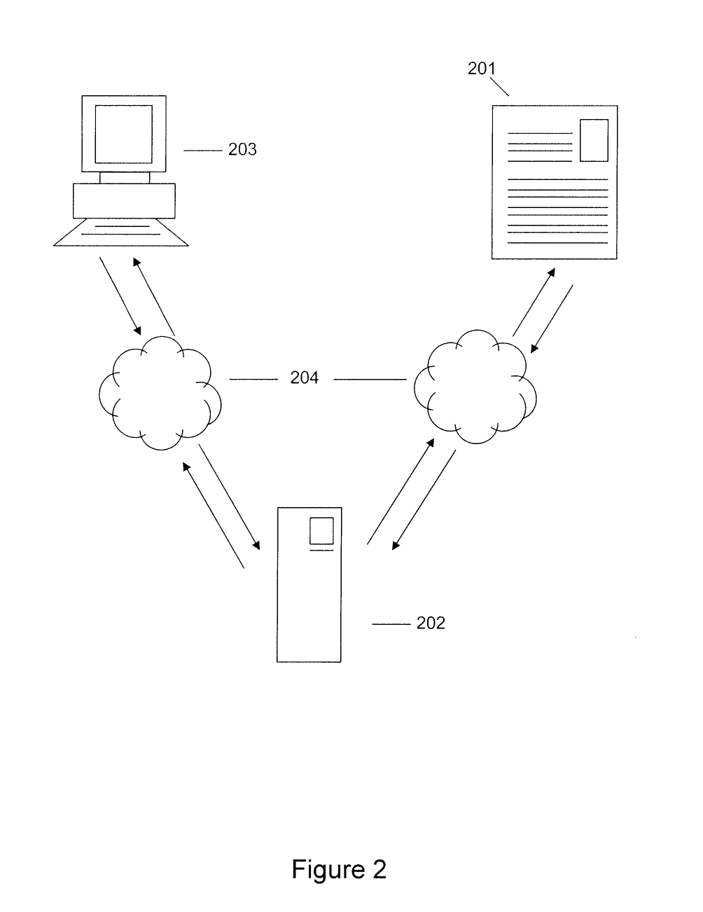

In certain embodiments, user interaction detection software can be delivered by means of a network proxy, as depicted in the example shown in FIG. 2. In this example, the user interaction detection client software may run within the network browser environment (e.g., via JavaScript) and may be loaded on a per-page basis using a proxy server. When user computer 203 seeks access to network resource 201, access to network resource 201 may be routed to proxy server 202. Proxy server 202 then accesses network resource 201. User computer 203, network resource 201 and proxy server 202 are typically configured to communicate using a network, which may be a common network 204 accessible bay all of the elements. In one example, the common network 204 is the Internet. Network resource 201 may be obtained by proxy server 202 and passed on to user computer 203, together with computer software code capable of interpretation and operation within the user computer 203. The software code, when executed by a computing device, implements certain processes and functions described herein. For example, the code may cause a processing device to detect user interactions with a network resource and to communicate RUII as more fully described herein.

In certain embodiments, proxy server 202 only communicates user interaction detection software code prior to, or following, transmission of the originally requested network resource 201. The user interaction detection software then may be executed within the program operating on user computer 203 that is responsible for the accessing and display of network resource 201.

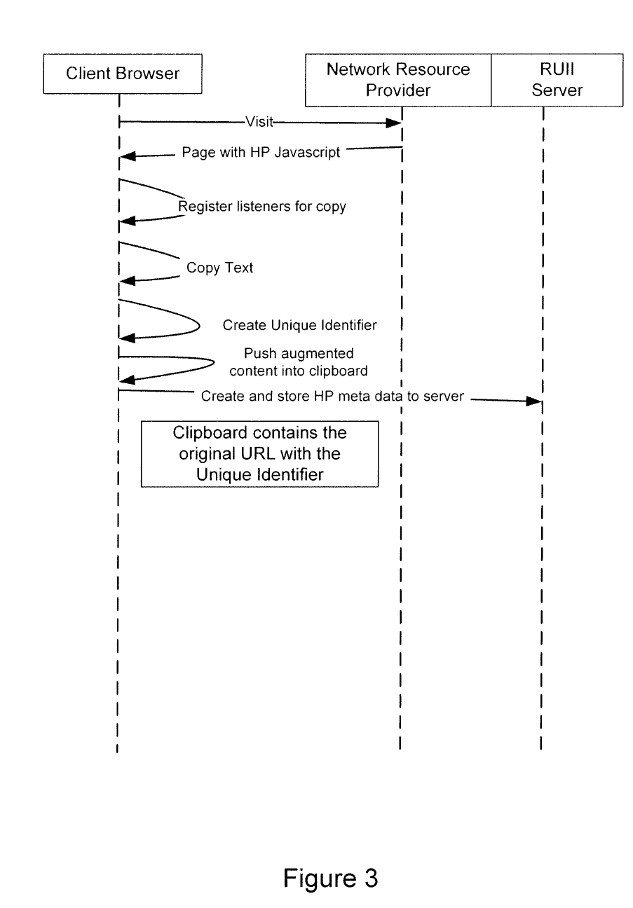

FIG. 3 illustrates an example of the communication process by which the client software present on the user computer (“Client Browser”) may provide information on user interactions to the RUII server according to certain aspects of the invention. Each network resource may carry with it a unique page identifier, such as a URL. The URL may be used for cataloguing RUII associated with the network resource. As the network resource is accessed on the user computer, Client Browser may communicate the page identifier to the RUII server and may optionally communicate additional identifying information. The additional identifying information may include one or more unique identifiers associated with the user computer and/or one or more unique identifiers associated with client software (e.g. userID). Software code capable of being executed on the user computer or within a program on the user computer, such as a client browser, for implementing for altering and reporting the occurrence of the user interactions contemplated by the present invention (“HP Javascript”) may be provided by the network accessible computer providing the network resource (“Network Resource Provider”) as presented in FIG. 3. Alternatively, the HP Javascript may be obtained from a computer other than the Network Resource Provider, including the RUII Server or other network accessible computer (not pictured) via a direction given by the Network Resource Provider to the Client Browser.

Optionally, supplemental information may be communicated to the client for presentation to the client through the client browser. Supplemental information may include general information thought to be of relevance to the particular network resource being viewed, an annotation associated with the network resource, or a given user ID. In one embodiment supplemental information may include an advertisement expected to be relevant to the user. In certain embodiments, supplemental information may include a link to an alternative network resource. Following the user interaction, if optional supplemental information has been received by the client, the supplemental information may be rendered together with the network resource for the user to view. Further, the substance and form of the supplemental information may be determined by the RUII, under direction of the RUII server or another computer in network communication with the user computer. Other types of supplemental information is described in more detail below, including supplemental information provided responsive to user interactions.

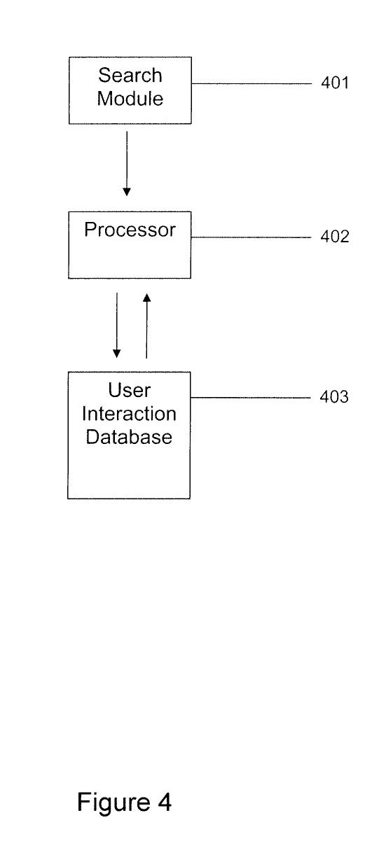

As shown in FIG. 4, a processor module 402 may integrate data obtained from search results received from a search module 401. It further is contemplated that user interaction database module 403 provide RUII to processor module 402 thereby enabling processor module 402 to modify the search results received so as to increase or decrease the relevance of a network resource within the search results. It is contemplated that search module 401 can be implemented either as a search engine accessible primarily by users of a user interaction detection system, or alternatively may be a search engine otherwise available to the public including, for example, search engines provided by Google® or Yahoo®. In one embodiment, the search engine may be any search engine preferred or desired by a user, with the search results generated by said search engine (i.e., search module 401) directed into processor module 402 for relevance sorting using data obtained from user interaction database module 403 which contains all or portions of the user interactions of a multiplicity of users on a multiplicity of network resources. Following relevance sorting, the search results, optionally re-ordered due to the increase or decrease of relevance of particular network resources contained within the search results, may be displayed to the user. In one embodiment, the user may choose between viewing the search results in their original order as obtained from search module 401, or the potentially modified search results arising from processing using the user interaction database.

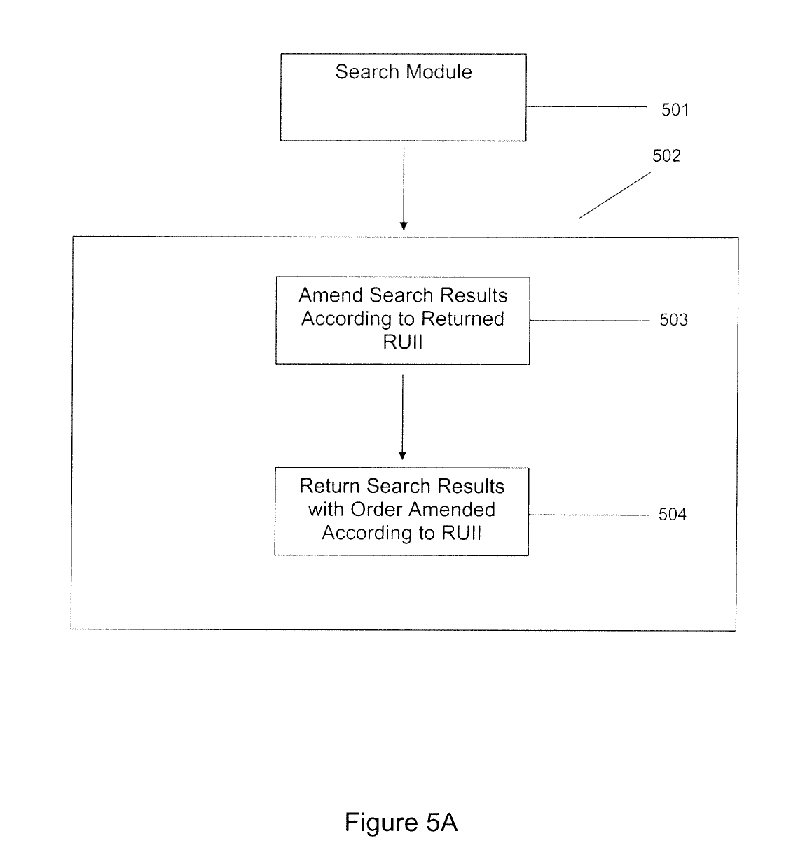

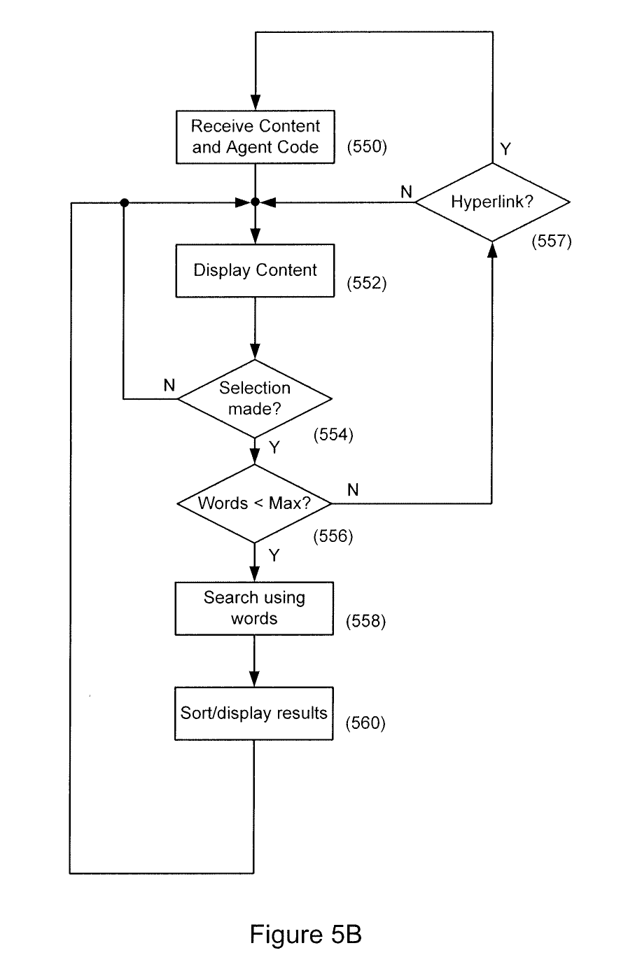

FIG. 5 shows a summary of a process that may be used within the processor module 402, as depicted in FIG. 4. Search results 501, corresponding to module 401 depicted in FIG. 4, may be imported into processor module 502, corresponding to module 402 depicted in FIG. 4. Sub-module 503 may amend the order of the search results according to information obtained from the user interaction database, which information may either increase or decrease the relevance of a network resource (and therefore, perhaps, the position within the ordered list of search results 501). Sub-module 504 may then return the amended search results to the user.

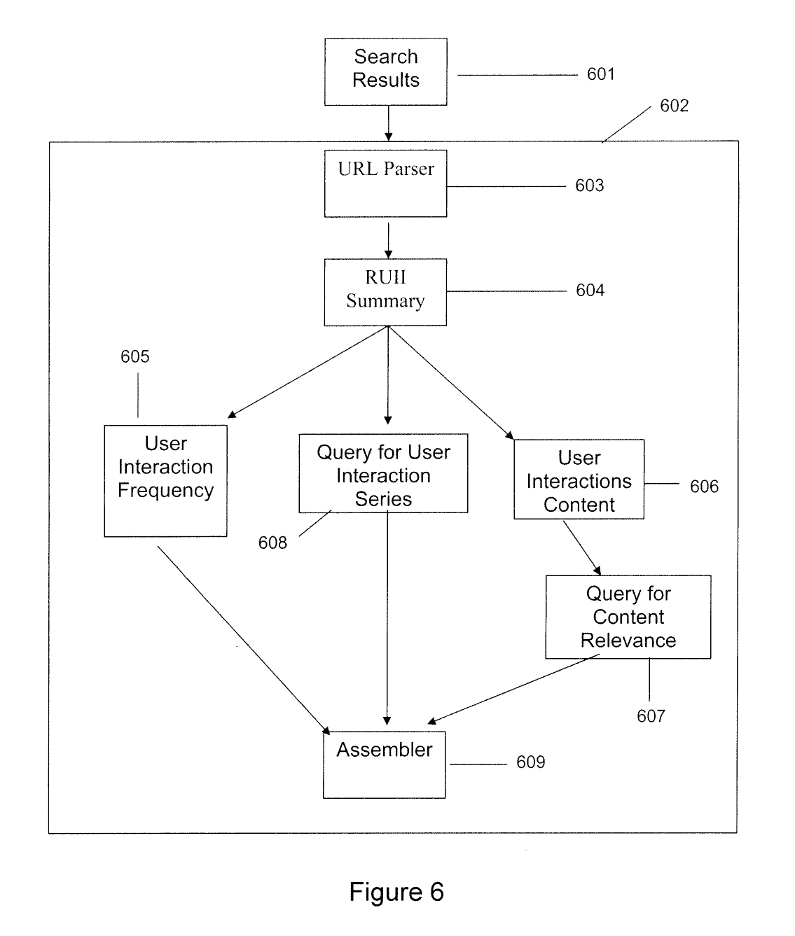

FIG. 6 shows further detail of the processing module 602, which previously was depicted as 402 in FIG. 4 and as 502 in FIG. 5. Search results 601 may be received into processing module 602 where they may be processed by sub-module 603, where the URL for each network resource forming the search results is reduced to a basic structure and compared to user interaction database to determine if RUII exist within the database for any of the URLs. By reducing a URL to a basic structure, it is contemplated that the URL is stripped of superfluous information not relevant or otherwise present in the copy event database. As an example of reducing a URL to its basic structure consider the following URLs:

1) examplesite.com/page1?cust=4,

2) examplesite.com/page1#anchor2. and

3) examplesite.com/page1#anchor2.

In this example, the basic structure of the URL may be examplesite.com/page1.

In one embodiment, the user interaction database may contain RUII made by plural, and/or all users of the user interaction detection system, which RUII may each be paired to a unique identifier for the network resource upon which the copy event was made. In certain embodiments, the user interaction database may be limited to a subset of RUII including, for example, RUII made by a particular user, a group of users of similar demographics, a group of users of similar geographic location, a group of users of similar language, a group of users of similar nationality, a group of users of similar employer, and so on. It is contemplated that any unique identifier for network resources may be used, and a functional equivalent of the URL parser used for each type of unique identifier of network resources.

When the URLs have been reduced into a basic structure and compared to the user interaction database, any RUII for the URLs within the search results may be assembled and summarized (604). It will be appreciated that the summary process may take many forms, with the goal to assess whether a RUII associated with a URL within the search results increases, or decreases, the relevance of that URL within the search results, which may in turn cause the network resource associated with that URL to be placed nearer to the top of the list of search results.

In certain embodiments, the presence of a RUII within the user interaction database associated with a given URL may indicate that a URL has increased relevance (“interaction frequency”). Furthermore, URLs with more RUII associated with them may be deemed more relevant than URLs with fewer RUII.

In certain embodiments, the content of the RUII associated with URLs may be used to determine if there exists certain terms within elements identified with an interaction with a network resource that may be associated with increased relevance of a particular URL (“content relevance”).

In certain embodiments, the action of the user interacting with multiple elements within a particular network resource, resulting in multiple RUII from a single user on a particular URL, including user interactions with combinations of text and images or combinations of text, either as part of a single operation or a series of user interactions can provide information with respect to the relevance of given network resources (“user interaction series relevance”). For the purposes of this description, a series of user interactions can be considered to comprise at least two user interactions occurring with respect to the same network resource, by the same user or client browser. The identification of user interactions as originating from the same user computer may be approximated through comparison of IP addresses at the time of the executing of a user interaction, or through other suitable means of identifying users, many of which are known in the art. For example, one method of identification includes user login information submitted in order to access a network resource. In another example, identification may be made by transmission to the client computer of a unique data identifier detectable at a later time (e.g. a “cookie” as is known in the art).

A series of user interactions by or on behalf of a single user may be used to derive associations between content within the page, providing additional user interaction series relevance. In one example, the act of a user interacting with more than one element within a single network resource may indicate that the user determined or considered the content elements to be related and/or relevant to each other. For example, if at least one of the content elements contains text and at least one other content element contains a non-textual content (including, for example, a video resource or image) the text (“contextual data”) may be associated with the non-textual content for the purposes of searching, including relevance. It is contemplated that each element subject to a user interaction as part of a series of user interactions by a user, communicated to, and stored by, the user interaction database can provide context for each of the other elements. It will be appreciated that the contextual data may comprise the entire text forming the copied element and/or may comprise key words identified within the text forming the copied element. Keywords may be selected using a dictionary of words or phrases determined to be relevant.

In certain embodiments, user interaction frequency and the presence of positive relevance data within RUII may together be used to increase the relevance of a particular network resource as among multiple search results. As shown in FIG. 6, sub-module 605 may assess the user interaction frequency, while sub-modules 607 and 608 may determine the presence of content relevance and user interaction series relevance, respectively, where sub-module 608 may be under the control of sub-module 606 which optionally parses textual content for interrogation by sub-module 608. The output of sub-modules 605, 607 and 608 may be received by assembler sub-module 609, which may weigh the outputs, and accordingly may increase or decrease the relevance of a given network resource within the list of search results. Assembler sub-module 609 may then provide to the user the list of search results, optionally reordered according to the relevance information.

In certain embodiments, the ordering within an ordered list of search results may be altered in order to place network resources with higher relevance closer to the top of the list. The ordered list may be maintained in its original state and a relevance “score” or weighting value can be applied to each network resource within the ordered list of search results. The weighting value or score may be displayed in association with the ordered list of search results, or alternatively may be displayed in a graphical fashion by, for example, color-coding, bolding, using a different font, etc.

### Deterring Traversal

Certain embodiments of the present invention provide methods and systems that can be configured to detect user interaction with network resources that are accessible within an electronic network. Information can be provided to a web publisher, a web site administrator and/or web site manager regarding the particular content that may be presented to the user in order to prevent the user from navigating to an alternative web site or network resource.

Certain embodiments employ an agent that includes a copy command intercept program that is capable of detecting certain actions by a user within at least the program capable of viewing a network resource. User actions can include copying of elements within the network resource, printing of the network resource, selecting elements within a network resource, or copying a URL identifying the network resource (“implicit user interaction”).

In certain embodiments, a copy command may include a “copy event” that causes the copy command intercept program to initiate transmission of the elements selected for copying into the user's copy/paste memory buffer on the computer through which the network resource is displayed. Optionally, additional content can be appended into the memory buffer, where such additional content may be defined by a manager or administrator of the first computer. The copy command intercept program can report implicit user interactions to at least one other computer in network communication with the second computer. The copy event information may also be stored in a database for aggregation and/or analysis. Copy event information can comprise the copied and/or selected content, the URL of the original article, the IP address/geographic location of the browser doing the copying, or other information generally known in the art as useful for identifying relevance of information to a user. This information can then be used by a web page manager/administrator to better understand which network resources, or elements within a particular network resource are popular, frequently copied or of increased relevance to the user.

In one example, copy event information is created from text or elements selected by the user. In this example, copy event information may comprise the selected text and elements and may be augmented by adding supplemental information derived using the selected text and other elements. Supplemental information may be obtained from prior histories and searches. In another example, copy event information created when the selected text is selected and/or copied by the user may be pasted when the user pastes copied text or elements.

In certain embodiments, copied content and/or copy event information can be directed to a memory resident on at least one other computer in network communication with the second computer upon which the user is viewing the network resource. The other computers may collect and analyze copy event information and/or may provide supplemental information related to the received copy event information. In certain embodiments, the copy event information is transmitted if the length of the copied content is below a predetermined or preconfigured threshold amount, typically measured by text string length and/or the number of words copied. For the purposes of this description, a word is defined as a string or sequence of text interrupted by a white-space character, a hyphen or a dash. When the user initiates a copy event, the additional content can optionally be pasted when the user initiates a paste. In one example, when the length of the copied content is below some predetermined threshold, the user may be offered the opportunity to search within the current web site, or a larger set of websites, using the copied content as a search term. The larger set of websites can optionally be selected by the web publisher, the manager of the network resource, web master, or other person generally in control of the material forming a network resource. In some embodiments, a search can be initiated using the copied content as search terms.

In certain embodiments, when a user undertakes an implicit user interaction with elements within the network resource, the software code may present to the user an offer of at least one hyperlink which leads to a network resource related to the element that is the subject of the implicit user interaction. In one example, a network resource may be a landing page relating to the element subject to an implicit user interaction. It will be appreciated that the presented hyperlinks may be obtained from a history of interactions and/or may be derived from a search.

In certain embodiments, software code can be communicated proximate in time, or concurrent with, the communication to a second computer of a network resource located on a first computer. For example, the software code may be embodied in a web page transmitted from a server to a user device. Code may contain instructions organized as one or more functions operating according to certain aspects of the invention, and some such functions are described herein. The network resource typically comprises digital content. The code may be executed proximate in time to the network resource display on the first computer using a program capable of viewing a network resource, such as a web browser. As a result, a copy command intercept program may be executed and/or called on the first computer capable of interacting with the program capable of viewing a network resource. The copy command intercept program is typically capable of detecting certain actions by a user within at least the program capable of viewing a network resource such as the copying of elements within the network resource, printing of the network resource, selecting elements within a network resource, or copying the URL of the network resource (“implicit user interaction”).

In certain embodiments, response to a copy command includes providing content to a manager/administrator when the content is copied by selection within displayed content and where the copied content has a size below some threshold. The size may be measured, for example, as a text length. In some embodiments, a management system may be deployed to characterize process the copied content. Content copied during a plurality of transactions can be aggregated and according to type and context of the copied content. Accordingly, information including the frequency of occurrence of types of content can be generated. In certain embodiments the frequency of copied content and/or portions thereof can be presented in a graphical format, such as a two dimensional matrix (e.g. a heat map in which the frequency of copying is represented as a color).

In certain embodiments, the presentation of content copied in response to user interactions can be a surrogate representation of content which is being utilized by users to form part of, or the entirety of, search terms to be used within a search engine accessing network resources. For example, an Internet search engine may be configured to access most or all of the network resources generally available to users and there is a strong likelihood that the user will be directed by the search engine to a network resource external to the web site presenting the network resource from which text or elements were selected and/or copied. Although network resources can be accessed through an Internet for the benefit of users, the provision of many network resources are supported in whole or in part through revenue generated by presenting advertising in conjunction with the network resource. This revenue is based on a number of factors, such as frequency of network resource viewings, average length of time users access any given network resource, the number of unique IP addresses accessing a network resource over a given period of time, etc. Therefore, revenue for the provider of the network resource (for example, including but not limited to a Web page manager, administrator, or web publisher) is directly related to the number of users that access the network resource. Efforts are made by providers of network resources to increase the number of users accessing their network resource (referred to as “traffic”). Increased presence of a resource in search engine results, earlier presentation of the resource within search results, reference in other network resources, and hyperlinks provided within other network resources can increase traffic. Thus, certain providers of network resources attempt to direct users to network resources in a manner that generates advertising revenue. In one example, a user may be directed to a network resource that is found in at least one domain in common with the originating network resource, a network resource found in a domain under common control, or a network resource under the control of another party with whom an agreement for revenue sharing or other consideration is paid. Thus, there is an advantage to a provider of network resources identifying user behavior which may result in a reduction of traffic within the domain or a collection of domains in which there is a relationship such as an advertising revenue sharing agreement.

Certain embodiments provide a system and method for monitoring user interactions with network resources, and more specifically for monitoring the copying of elements within a network resource. The act of selecting and/or copying text strings is frequently performed for the purpose of using the text to form at least a portion of a text string to be used in a search of network resources by a search engine. Typically, search terms are limited in size and a threshold value can be selected that increases the probability that selections are intended for use as search terms. In certain embodiments, the threshold number of elements can be a number of words copied (e.g. 7 or less), where a word is defined as a string or text interrupted by a white-space character, a hyphen or a dash. Further, the copying of textual elements below the selected threshold size can be monitored and, as appropriate, provided to the provider of network resources. Increased frequency of words or phrases forming part of the copied content may be assessed, and the provider of a network resource may then generate supplemental information for the currently viewed resource. The supplemental information can comprise references within the network resource, references within the network resource's domain, and/or references within other domains to which the provider of the network resource would like to direct traffic.

In certain embodiments a provider of a network resource may attempt to intervene or otherwise interrupt the user's insertion of the copied content into a search engine of the user's election. For example, the provider of the network resource may automate a process occurring contemporaneously with viewing of a network resource, where selecting and/or copying content results in the presentation to the user of an opportunity to use the copied content as search terms for searching within the current domain, a selection of domains elected by the provider of the network resource, and/or the wider network. The opportunity may be provided as a set of initial results. The results may prioritize domains elected by the provider of the network resource.

Certain embodiments of the invention may be used to improve a user's experience when viewing a network resource. The selection and/or copying of words below a certain threshold can be associated with an intent of the user to perform specific acts including, for example, where the copying of words below a certain threshold preceded search activities of the user. Accordingly, a web publisher, manager or web master may be provided an opportunity to change the workflow of the user prior to the user leaving the network resource, or network resource domain, to undertake a web search. Thus, upon detection of the copying of words below a certain threshold, a user may be presented with one or more of:
content related to the copied text as determined by an automated text search of a subset of all network resources generally available, or a set of network resources within a network domain or collection of network domains;
pre-selected advertisements related to certain of the copied text;
content related to the copied text as determined by a search of a subset of all network resources generally available, or a set of network resources within a network domain or collection of network domains using search techniques or search engines as known in the art;
network resources related or relevant to the copied text; and
offers of search functions to the user using the copied text as a search element.
   The presentation of such additional information may employ any suitable technique, including pop-up windows, super-imposition, prompts, and so on.

Assessment of users undertaking an implicit user interaction with elements present in a network resource may be used to further enhance the user experience within the network resource by offering up, or access to, additional network resources and/or to direct or present to users network resources from which the publisher, manager or administrator of the network resource may generate additional revenue including, for example, landing pages. A landing page may be generated and/or identified following the identification of elements within a network resource subject to implicit user interactions (based on frequency, for example). The landing page may be a pre-existing page and can be identified based by on implicit user interactions with relevant elements. The landing page dynamically can be generated as needed. Offers and direction to additional information can be provided using any of a plurality of available techniques known in the art, including:
a “pop-up-window” operating within the program capable of viewing the network resource;
a hyperlink created within the network resource, identified in a manner consistent for hyperlinks within the program capable of viewing the network resource;
a representation of a hyperlink in a manner different than hyperlinks are generally represented within the program capable of viewing the network resource;
the generation of a graphic, distinct from the network resource, which offers the user access to network resources from which the publisher, manager or administrator of the network resource may generate additional revenue;
presentation of an opportunity to access the network resource upon a user undertaking a “mouse-over” event on an element within the network resource; and/or
presentation within the network resource of a frame offering the user to access network resources from which the publisher, manager or administrator of the network resource may generate additional revenue.

In certain embodiments, the content of additional network resources may include, for example:
Related content from the initial network resource
Related content from a web feed or aggregated web feed, by way of non-limiting example, those made available by service providers such as Yahoo!
Display or text ads related to the content of elements copied by the user or subject to an implicit user interaction
Search results from a search engine relating to the of elements copied by the user or subject to an implicit user interaction, or subject to past copying or implicit user interaction from persons other than the instant user, where the searched network resources may be limited to network resources within the domain of the network resource, within a subset of domains containing network resources, or for all generally available network domains
Similar network resources as suggested by the publisher, manager or administrator of the network resource; or their agents were the network resources may be limited to network resources within the domain of the network resource, within a subset of domains containing network resources, or for all generally available network domains
Images contained in, or comprising network resources, where the network resources may be limited to network resources within the domain of the network resource, within a subset of domains containing network resources, or for all generally available network domains
Other content discovery objects such as a flash presentation of engaging, popular or related content
Promoted content that is not directly related to the search copy
Contextual content or ads based on the demographic profile of the user that was directed to the landing page

In certain embodiments, the past history of a user can be used advantageously to improve the relevance of the additional network resources offered to users, or in the alternative the network resources from which the publisher, manager or administrator of the network resource may generate additional revenue and results may be prioritized based on the relevance and/or past history. In one example, relevance may be improved by one or more of identification of a referral link that brought the user to a network resource implementing aspects of the present invention, by “cookies” which enable the monitoring of past user history, elements within the network resource subject to an implicit user interaction and/or elements within the network resource that have been subject to an implicit user interaction by other users. An implicit interaction of a user with elements of a network resource can include the selecting/copying of elements within a network resource, particularly where the amount of content copied is less than some threshold length. In certain embodiments, such copying represents and/or identifies an intention to undertake a search of network resources and the copied content and determination of content can be used to improve the user experience, increase the likelihood of maintaining that user within a domain or subset of domains of network resources and/or increase traffic to a network resource. In certain embodiments, the monitoring of implicit interactions by a multiplicity of users with network resources can provide contemporaneous information as to content or elements that users find relevant within a network resource. An implicit user interaction can be approximated as an expression of relevance of that content or element.

FIG. 5B illustrates an example of providing a referral link according to certain aspects of the invention. At step 550, a web page, content or other resource is delivered to the user together with software code (an agent) that is typically communicated proximate in time with, or concurrent with, the communication of the resource. At step 552, the content is displayed and the code is used to monitor use interactions with the display content. If at 554, a selection or mouse-over of certain text is detected, it is determined at 556 if the number of words in the selection is less than a predetermined or configured number. If the number of words is less than the threshold value, then a search can be initiated at step 558 by providing search terms derived from the selection to a search engine. Results received at 560 may be sorted, prioritized and displayed in a pop-up, hover or other window or in a pull-down menu or by any means known in the art together with content at step 552. If at step 554, no selection was made, display is continued at step 552. If at step 556, the selection was of more than a threshold level or, if the selection was of a hyperlink or other object, then the selection is examined for other functions. At step 557, a hyperlink causes retrieval of new content at 550 or return to display of previous content at step 552.

In certain embodiments, the elements or content of network resources subject to an implicit user interaction can be monitored to identify trends within a population of users. This may be undertaken through monitoring of changes in the presence of certain keywords within the elements or content subject to an implicit user interaction, frequency of users undertaking an implicit user interaction, or particular form thereof; or combinations. Rather than simply using search terms or search queries within a set of network resources as a means of identifying trends within a population, according to certain aspects of the invention provide monitoring based on implicit user interactions rather than relying solely on explicit actions of the user such as entering a search term.

The elements or content of network resources subject to an implicit user interaction may be retained and correlated to time, a URL of the network resource, the content of the network resource, location and/or derived information relating to the user (such as location determined by means of a “cookie”, a required login of the user to access the network resource, or by the IP address of the user accessing the network resource). Such information can provide historical data for analysis. In certain embodiments, the content or elements that are the subject of an implicit user interaction, or the network resource from which they originated, may be parsed into a library of keywords, which are then correlated to time, location or derived information relating to the user undertaking the implicit user interaction, the URL of the network resource subject to the implicit user interaction and/or at least a portion of the content of the network resources subject to the implicit user interaction, which can provide historical data for analysis. In certain embodiments, the trending of quantity or frequency of implicit user interactions can be produced with or without comparisons to, or inclusion of, keyword presence in search reports. Search reports may be graphically represented as a timeline or presented using one or more suitable algorithms. Some embodiments can include an analysis of changes in keyword frequency arising from search terms used to query a population of network resources (i.e. an internet search record), or using trend analysis engines based on population actions as an input. In certain embodiments, these and other approaches can be used to monitor the presence, increased presence, or frequency of keywords occurring within elements or content subject to implicit user interactions. Examples of trend analysis methods and systems can be found in United States Patent Applications #20090182725 or #20100100537, which applications are herein incorporated by reference.

Certain embodiments of the invention employ a network resource user interaction detection system is employed that can identify and communicate user interactions with a network resource. The interaction detection system may additionally maintain information related to an interaction including, for example, information describing the occurrence, content associated with the interaction and one or more terms identified within text elements that were a subject of a user interaction and part of the user interaction detection (referred to herein as “relevant user interaction information” or “RUII”). The information related to the interaction can be maintained apart from the user computer.

### Object Creation

Certain embodiments of the invention can increase the relevance of a network resource within search results by increasing the number of references to a network resource within the network, wherein the increase of references correlates with user interactions. Such display of search results can have a direct impact upon publishers and providers of network resources on networks, including the Internet. Many publishers or providers of network resources generate revenue from the display of advertisements in association with the network resource and a quantum of revenue can be correlated with the number of users accessing/viewing the network resource. Thus, there is an advantage to a network resource receiving a more preferred placement within an ordered list. Those parties providing search engine services seek to provide relevant search results based upon, amongst other factors, relevance. Therefore it is generally in the interests of a provider and/or publisher to present its network resources in a manner that increases the apparent relevance of the network resource when assessed by a search engine. Conventional methods of increasing relevance may include the addition or inclusion of keywords in the resource that are known to be subject of searches by users of a search engine. Keywords can be added in the displayed text or within hidden metatags. Alternatively, certain search engines (such as Google™) utilize the number of other network resources providing reference to, or “links” to, a network resource as a measure of relevance with respect to certain terms or keywords present within the network resource.

Certain embodiments of the invention provide systems and methods that enable providers and/or publishers of network resources to increase the number of links to a particular resource in association with words, phrases or keywords using implicit interaction of users with the network resource. An implicit interaction with a network resource by a user can be a reasonable proxy for a user's determination that an element within the network resource and, therefore, the network resource, is valuable or relevant. As the population of users communicating implicit interactions with network resources increases, so too will the number of references, or links, to the network resource, and by corollary its relevance within certain search engine results. Therefore, the present invention can advantageously increase the number and identifiable quality of links related to a network resource, and can identify words, phrases and/or keywords within the network resources that users identify as relevant.

In certain embodiments, search results may be improved by limiting the search to a subset of network resources, the subset being defined as those network resources containing elements with which other users have interacted. Certain implicit interactions of users with network resources can identify a network resource or a portion of the network resource as having increased relevance. In one example where the network resource is presented as a web page, implicit interactions indicative of increased relevance include copying of elements within the web page, printing of the web page, selecting elements within the web page and copying the URL of the web page. Therefore, it can be advantageous to create a searchable index of network resources, or elements within the network resources, with which a user has had an implicit interaction.

According to certain aspects of the invention, a combination of hardware and software may embody the user implicit interaction detector. The user implicit interaction detector may comprise a web browser capable of detecting implicit interactions with a network resource within the browser. The user implicit interaction detector may report an implicit user interaction to a third computer in network communication with the second computer. The occurrence of the implicit user interaction may be stored in a computer readable memory for analysis along with implicit user interaction information comprising, for example, what the content interacted with in a network resource was, the URL of an original article, the IP address/geographic location of the web browser, and/or other information generally known in the art as useful for identifying relevance of information to a user. The third computer may then direct the generation of a unique URL for the content interacted with by the user, and may generate a searchable index comprising a series of unique objects, each with its own unique URL, and the content, or a subset of the content, with which the user has interacted. Subsets of the content subject of interactions with the user may be limited to certain keywords identified as possessing relevance to one or more searches. In certain embodiments, images may be indexed using metatag information maintained or referenced by an original network resource in which the image was contained. In some embodiments, images may be referenced using any text which was interacted with by a user simultaneous to (or proximate in time to) an interaction with the image.

In certain embodiments, software code related to implicit interaction detection is communicated proximate in time, or with a network resource (e.g. web page). The code may execute in conjunction with and/or proximate in time to the display of the network resource. Thus, the code may be provided as a plug- or add-on module to a web browser and is configurable to detect implicit interactions of a user of the web browser with the network resource. The code may comprise a module that communicates implicit interactions to a different computer using a network, where the different computer can process the implicit interactions to obtain statistical analyses, accounting and other administrative information as well as generating search terms and/or performing searches related to the implicit interactions and/or a history of implicit interactions. Information related to user implicit interactions can be stored in a computer readable memory for collation, aggregation and other analysis along with implicit user interaction information comprising one or more of content, identification of a related network resource, URLs (e.g. of the original article), IP address of a device capturing and/or detecting implicit user interactions, biographical information related to the user, including geographic location, etc.

In certain embodiments, a computer may be configured to generate a unique URL identifying content subject to user interactions. The content may include a hyperlink to an original network resource, and user related information. The information and content may be provided to the network for identification by index searcher services. In certain embodiments, each implicit user interaction with a network resource generates a new object within the network, referencing the original network resource, and thereby increasing the number of hyperlink references to the network resource within the network. As the number, or frequency, of links to a network resource within a network is assessed by certain search engines, indexers, or network crawlers/trawlers, the measure of the relevance of the network resource when reporting search results to a user in response to a query increases.

In certain embodiments, an implicit interaction of a user with a network resource may comprise an interaction by the user with the network resource that is not necessarily intended to communicate an interest in the content of the network resource. Accordingly, implicit interactions can include, selection of elements of a displayed resource, saving of elements and/or portions of a resource, printing of certain elements of a network resource and copying of the URL of the network resource. In the example of displayed network resource that comprises a web page, elements and/or portions of the web page can be selected using a mouse, trackball, touchpad, touch-screen, navigation keys and/or voice recognition to identify the portion of the web page to be selected, this latter portion typically being highlighted or otherwise displayed differently in acknowledgement of the selection. In one example, most programs capable of viewing a network resource, such as internet browsers, allow the selection of text by the user which results in the modification of the display of the text to the user; for example by inverting the colors (e.g. white to black) of the text and its surrounding area.

In certain embodiments, a detection system capable of identifying and communicating user interactions with a network resource communicates the occurrence of a user's implicit interaction with a network resource and, optionally, content and resource identification related to the interaction. Implicit user interaction information (“lull”) may be communicated to one or more different devices, including a centralized IUII server. In certain embodiments, the user interaction detection system comprises an IUII server in network communication with a user computer, whereby the IUII server receives IUII from a client on the user computer. The system may store the IUII of a user on an IUII server different from the web server hosting the subject network resource and may further include formatting information in the IUII in order to localize the user interaction within the network resource, for example.

FIGS. 1-3, described previously, illustrate various aspects of the relationship between network resources 201 RUII, servers 102, 202 and user computer 103, etc. It can be appreciated that implicit interactions may be considered relevant and that certain embodiments may capture and process IUII using the systems and methods described in FIGS. 1-3. However, it is contemplated that IUII may be distinguished from RUII in some cases and may be subjected to additional processing. For example, an element may be immediately considered relevant if the element is selected and copied, whereas an implicit interaction may be considered less relevant unless the selection is copied, linked, printed or identified for sharing and/or inclusion in metadata, etc. Selections and mouse-over interactions may be counted and, if a certain number or frequency of implicit interactions occur, then an individual implicit interaction may be immediately considered relevant. However, in many embodiments, any implicit interaction is considered relevant and the occurrence of the interaction is typically recorded such that a measure of relevance can be calculated from aggregation of such interactions.

In certain embodiments, IUII can be obtained from user interactions with a variety of documents and network resources including, for example, application specific documents, proprietary format documents such as Microsoft Word™ or PDF files, video content, audio content and databases.

The various systems, modules, etc. described herein may each include a storage component for storing machine-readable instructions for performing the various processes as described and illustrated. The storage component may be any type of machine-readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer-readable) storing medium. Each computer system, as will be illustrated in more detail below, may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

### System Description

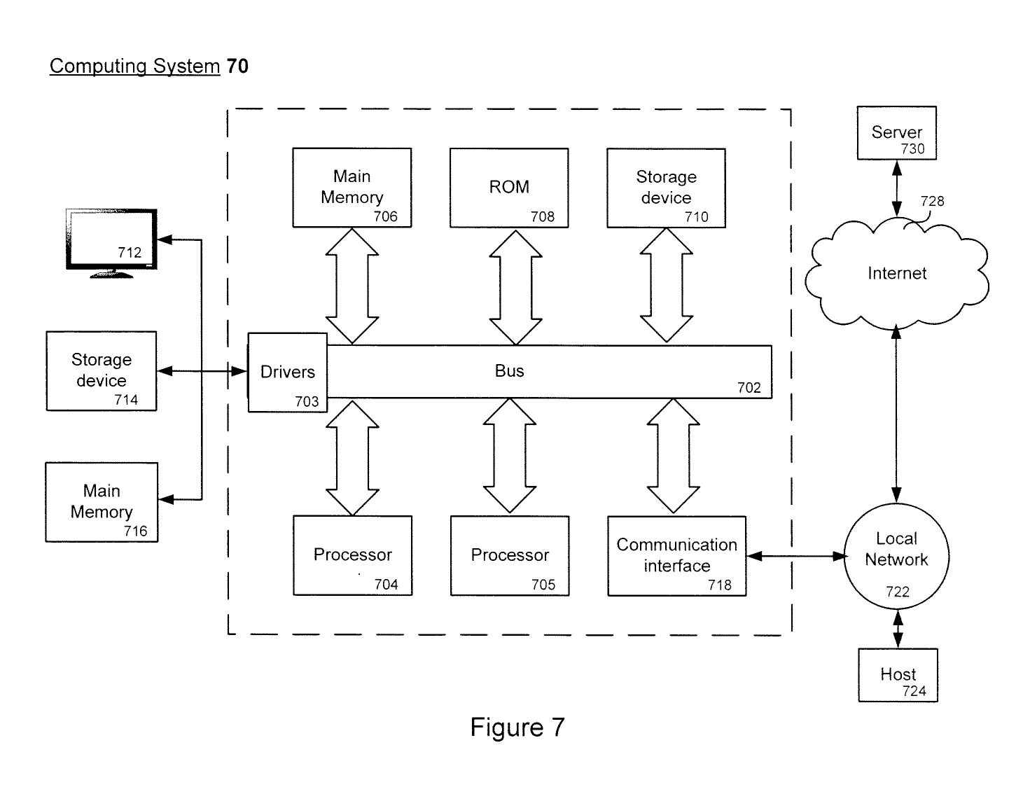

Turning now to FIG. 7, certain embodiments of the invention employ a processing system that includes at least one computing system 70 deployed to perform certain of the steps described above. Computing systems may comprise a commercially available system that executes commercially available operating systems such as Microsoft Windows®, UNIX or a variant thereof, Linux, a real time operating system and/or a proprietary operating system. The architecture of the computing system may be adapted, configured and/or designed for integration in the processing system, for embedding in one or more of an image capture system, a graphics processing workstation, a desktop or laptop computer, a server and/or a mobile device including cellular and other telephones, PDAs, smart phones and the like. In one example, computing system 70 comprises a bus 702 and/or other mechanisms for communicating between processors, whether those processors are integral to the computing system 70 (e.g. 704, 705) or located in different, perhaps physically separated systems. Device drivers 703 may provide output signals used to control internal and external components.

Computing system 70 also typically comprises memory 706 that may include one or more of random access memory (“RAM”), static memory, cache, flash memory and any other suitable type of storage device that can be coupled to bus 702. Memory 706 can be used for storing instructions and data that can cause one or more of processors 704 and 705 to perform all or a portion of a desired process or method. Main memory 706 may be used for storing transient and/or temporary data such as variables and intermediate information generated and/or used during execution of the instructions by processor 704 or 705. Computing system 70 also typically comprises non-volatile storage such as read only memory (“ROM”) 708, flash memory, memory cards or the like; non-volatile storage may be connected to the bus 702, but may equally be connected using a high-speed universal serial bus such as USB, Firewire, SATA or other such bus that can be coupled to bus 702. Non-volatile storage can be used for storing configuration, and other information, including instructions executed by processors 704 and/or 705. Non-volatile storage may also include mass storage device 710, such as a magnetic disk, optical disk, flash disk that may be directly or indirectly coupled to bus 702 and used for storing instructions to be executed by processors 704 and/or 705, as well as other information.

Computing system 70 may provide an output for a display system 712, such as an LCD flat panel display, including touch panel displays, electroluminescent display, plasma display, cathode ray tube or other display device that can be configured and adapted to receive and display information to a user of computing system 70. Typically, device drivers 703 can include a display driver, graphics adapter and/or other modules that maintain a digital representation of a display and convert the digital representation to a signal for driving a display system 712. Display system 712 may also include logic and software to generate a display from a signal provided by system 700. In that regard, display 712 may be provided as a remote terminal or in a session on a different computing system 70. One or more input device 714 is generally provided locally or through a remote system and typically provides for alphanumeric input as well as cursor control 716 input, such as a mouse, a trackball, etc. It will be appreciated that input and output can be provided to a wireless device such as a PDA, a tablet computer or other system suitably equipped to display the images and provide user input. It will be appreciated that device drivers may be modified and/or interfaces to device drivers may be provided that permit interception of user input as described above.

According to one embodiment of the invention, at least a portion of the functions described above can be performed by a computing system 70. Processor 704 executes one or more sequences of instructions. For example, such instructions may be stored in main memory 706, having been received from a computer-readable medium such as storage device 710. Execution of the sequences of instructions contained in main memory 706 causes processor 704 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 704 and/or 705, particularly where the instructions are to be executed by processor 704 and/or 705 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 704 and 705 or remotely, typically by use of network connection. Non-volatile storage may be removable from computing system 704, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 70. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 704 and/or 705. For example, the instructions may initially be retrieved from a magnetic disk of a remote computer and transmitted over a network or modem to computing system 70. The instructions may optionally be stored in a different storage or a different part of storage prior to or during execution.

Computing system 70 may include a communication interface 718 that provides two-way data communication over a network 720 that can include a local network 722, a wide area network or some combination of the two. For example, an integrated services digital network (ISDN) may used in combination with a local area network (LAN). In another example, a LAN may include a wireless link. Network link 720 typically provides data communication through one or more networks to other data devices. For example, network link 720 may provide a connection through local network 722 to a host computer 724 or to a wide are network such as the Internet 728. Local network 722 and Internet 728 may both use electrical, electromagnetic or optical signals that carry digital data streams.

Computing system 70 can use one or more networks to send messages and data, including program code and other information. In the Internet example, a server 730 might transmit a requested code for an application program through Internet 728 and may receive in response a downloaded application as described in the examples above. The received code may be executed by processor 704 and/or 705.

### Example

### Action Rank Measure of Engagement on Web Pages

Examples of web-based searches are described. Websites with thousands of web pages are commonplace and such websites include blogs (e.g. typepad.com), online publishing (e.g. nydailynews.com) and advertisement websites (e.g. kijiji.com). Conventionally, domain searches are used to find the information of interest in such sites. Most search engines have no problem at identifying related pages, but ranking them is usually difficult because, traditionally, search engines exploit the linkage structure of the web pages to assign authorities to web pages and to rank them based on their authority values (e.g., PageRank and Authority and Hub). This method fails under some circumstances, including where contents are posted by registered users with very few hyperlinks on their web pages (e.g. blogs) and where most recent pages are more important than older pages (e.g. newspaper). In the latter case, links may have not been developed yet. For the purposes of illustration, a novel measurement of user engagement on web pages (referred to here as “Action Rank”) can be employed in these types of sites. The advantage of this measurement is that it does not rely on any linkage or content information of the web pages. Action Rank is based on user actions on web pages, including views, selections and copies as described above. It is demonstrated that top results returned by Action Rank are more recent and relevant.

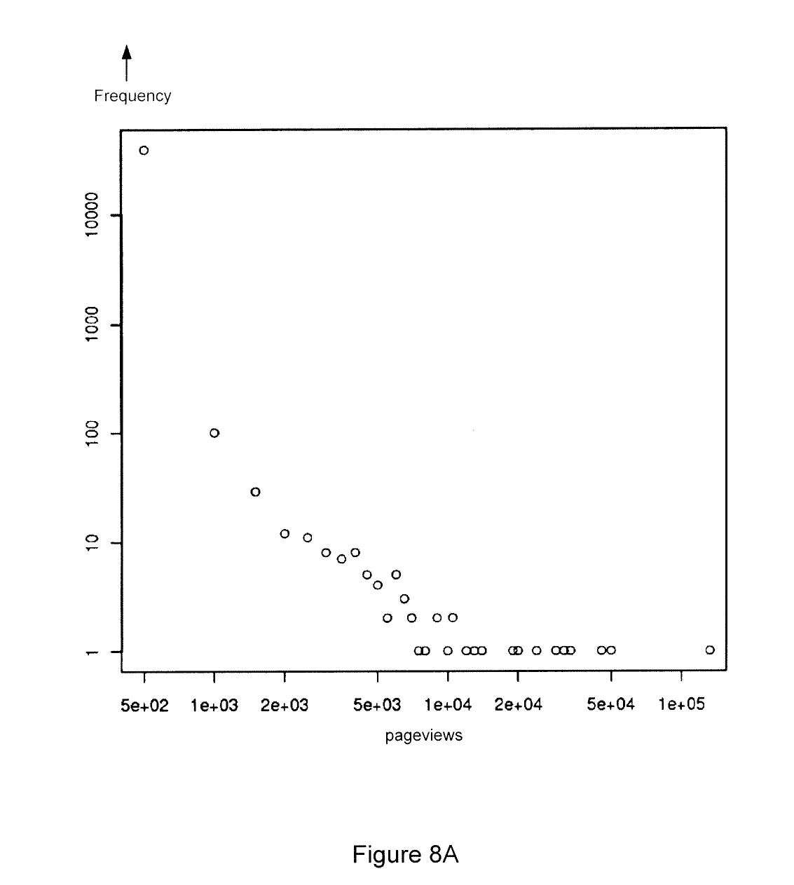

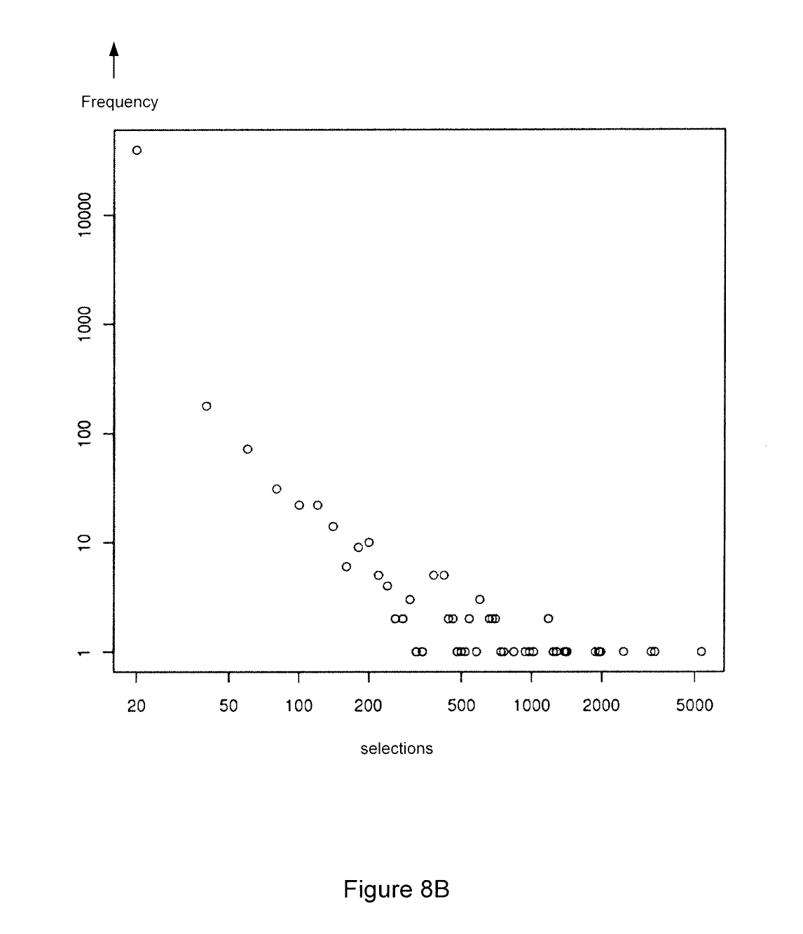

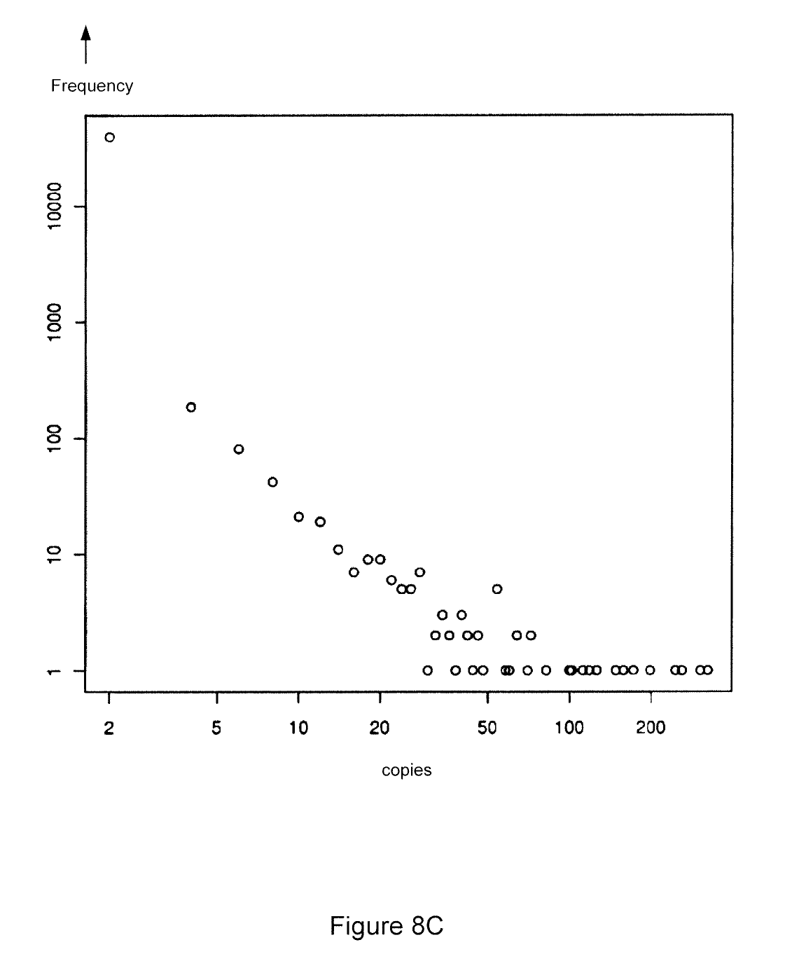

Results depicted in FIGS. 8A-8C, show that the number of page views (FIG. 8A), selections (FIG. 8B) and copies (FIG. 8C) on web pages follow power-law distribution. The equation of power-law distribution may be written:

P(x)=Cx^{-α},

where: x is the raw measurement (e.g. 100 page views),
P(x) is the probability of x (e.g. the probability of a random page having 100 page views), and
C and α are data-dependent parameters.
   In one embodiment, Action Rank is computed for a webpage in three steps. For the purposes of this discussion, a web page is assumed to have 1000 page views, 100 selections and 10 copies. First, Eq. 1 transforms raw metrics x to probabilities p(x). For the web page, the probability of its page view is:

P(1000)=C_{views}*1000^{-α}^{_{views}}

Similarly, selections and copies can be transformed as:

P(100)=C_{selections}*100^{-α}^{_{selections}}

P(10)=C_{copies}*10^{-α}^{_{copies}}

It will be appreciated that probabilities become smaller as the raw metrics increase. It is the nature of probability (the probability of a random webpage having 1000 page views is smaller than it having 100 page views). However, the final Action Rank score provides web pages with more actions with larger values. Accordingly, the second step includes creating an inverse of the probabilities:

$$f ( x ) = \frac{p ( min ) - p ( x )}{p ( min ) - p ( max )} = \frac{C * {min}^{- α} - C * {x}^{- α}}{C * {min}^{- α} - C * {max}^{- α}} = \frac{{min}^{- α} - {x}^{- α}}{{min}^{- α} - {max}^{- α}}$$

At least one action is required in most cases, and thus:

$$f ( x ) = \frac{1 - {x}^{- α}}{1 - {max}^{- α}}$$

Finally, the three actions are combined by multiplying the values together:

$$AR ( {x}_{views} , {x}_{selections} , {x}_{copies} ) = f ( {x}_{views} ) * f ( {x}_{selections} ) * f ( {x}_{copies} ) = \frac{1 - {x}_{views}^{- {α}_{views}}}{1 - {max\_views}^{- {α}_{views}}} * \frac{1 - {x}_{selections}^{- {α}_{selections}}}{1 - {max\_selectrions}^{- {α}_{selections}}} * \frac{1 - {x}_{copies}^{- {α}_{copies}}}{1 - {max\_copies}^{- {α}_{copies}}}$$

$$In the example , the Action Rank is \text{:} \\ = \frac{1 - {1000}^{- {α}_{views}}}{1 - {max\_views}^{- {α}_{views}}} * \frac{1 - {100}^{- {α}_{selections}}}{1 - {max\_selections}^{- {α}_{selections}}} * \frac{1 - {10}^{- {α}_{copies}}}{1 - {max\_copies}^{- {α}_{copies}}} \\$$

where the maxima are domain-dependent, which ensures that for small domains with limited traffic, some of their web pages can still get relatively high Action Ranks. The only unknown parameters in the above equation is the three α, which can be obtained by fitting the data into power law distribution. Using the R function given by Eq. 1, the optimal α for nydailnews.com in the table below:

| Date | α_{views} | α_{selections} | α_{copies} |
|---|---|---|---|
| 2009-05-24 | 1.7 | 1.8 | 1.98 |
| 2009-05-25 | 1.68 | 1.8 | 1.98 |
| 2009-05-26 | 1.71 | 1.82 | 2.02 |
| 2009-05-27 | 1.68 | 1.76 | 1.9 |
| 2009-05-28 | 1.69 | 1.67 | 1.92 |
| 2009-05-29 | 1.71 | 1.72 | 1.92 |
| 2009-05-30 | 1.69 | 1.68 | 1.94 |
| median | 1.69 | 1.76 | 1.94 |

As can be seen from this example, the parameters are quite stable across days, so the medians (1.69, 1.76, 1.94) can be used for computation purpose.

### ActionRank in Ranking Search Results

To demonstrate how Action Rank can be used to improve search results, a search engine based on Apache Lucene can be used to download all the web pages from a target site (here, nydailynews.com), which were viewed at least once on Aug. 25, 2009. These web pages are indexed as a search pool, and for each web page, an Action Rank is computed based on the actions received on Aug. 25, 2009. Lucene has a built-in content-based search scheme, which is a modified version of TFIDF. When returning the search results, it provides not only a list of related web pages, but also the scores which measure their content-based similarity to the query. This list can be used for each page to combine the page Content-based Similarity Score (CSS) given by Lucene and its pre-computed ActionRank score (AR) as follows:

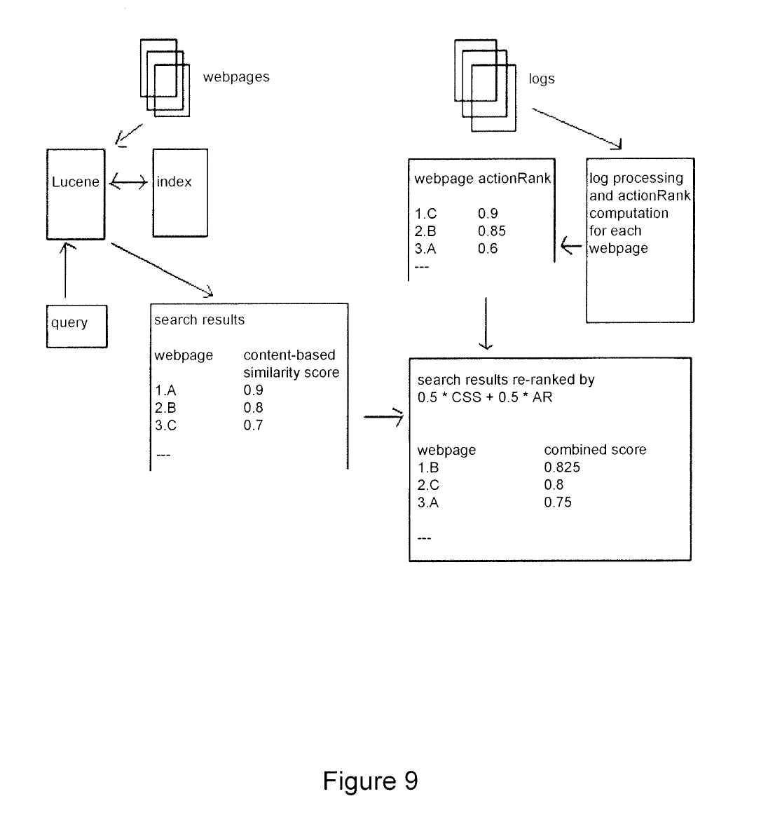

CS(w)=β*CSS+(1−β)*AR

where is a tunable parameter, which controls how much weight each score should be given. Based on the new Combined Score (CS), the list given by Lucene can be re-ranked. This process is illustrated in the FIG. 9.

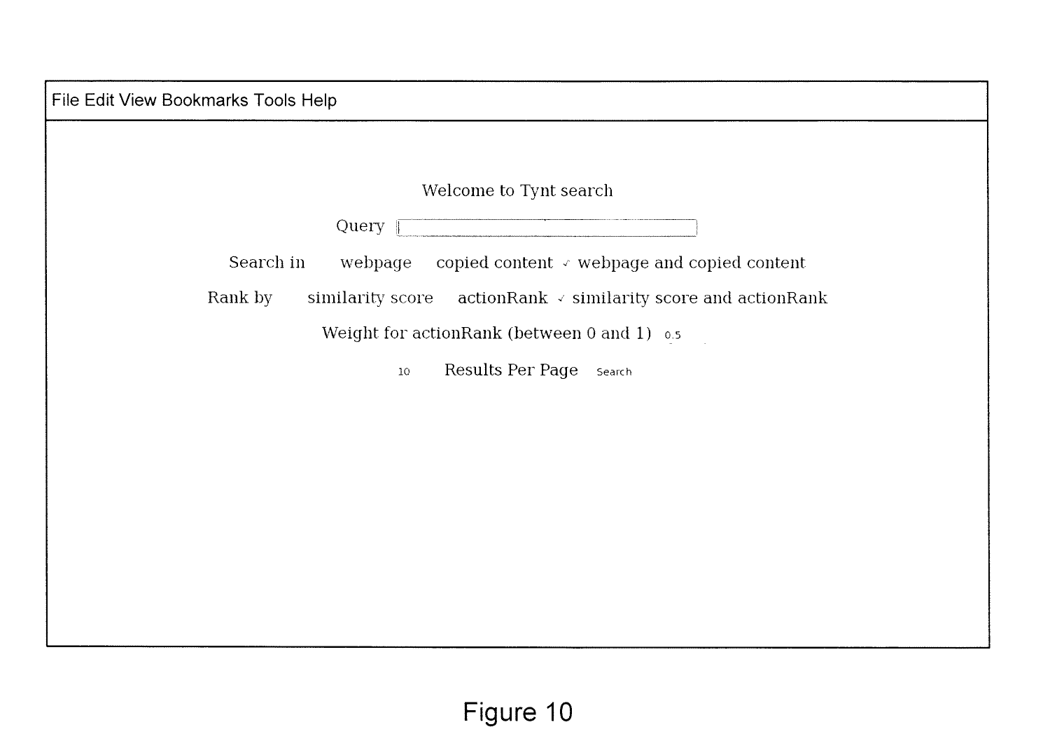

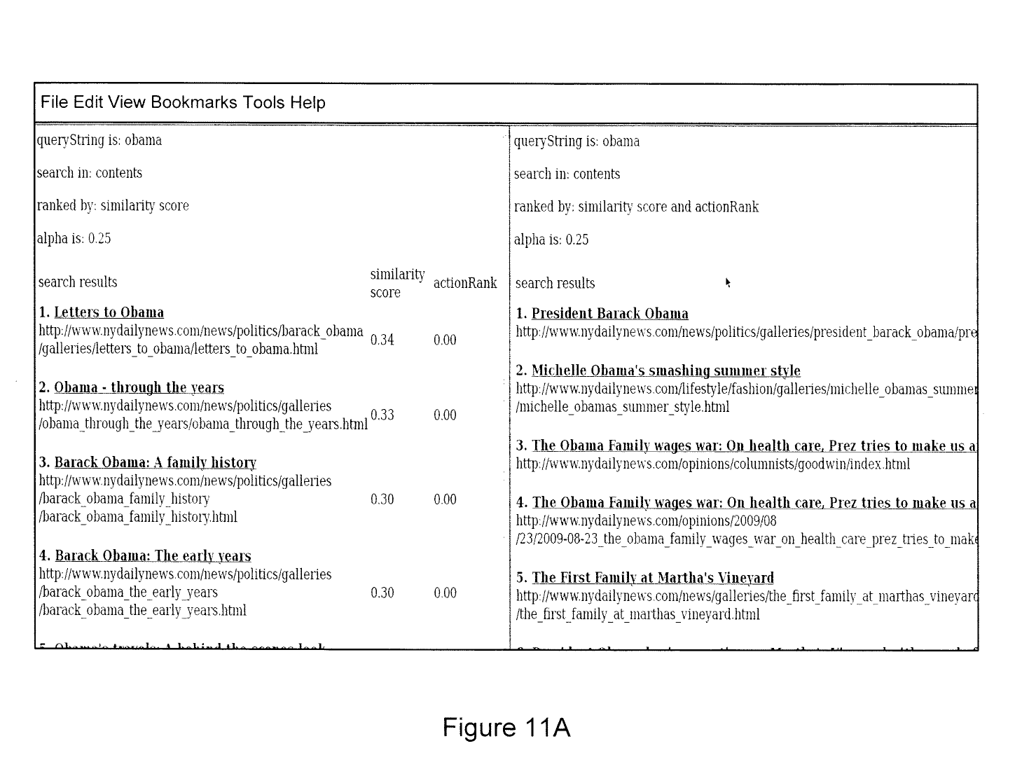

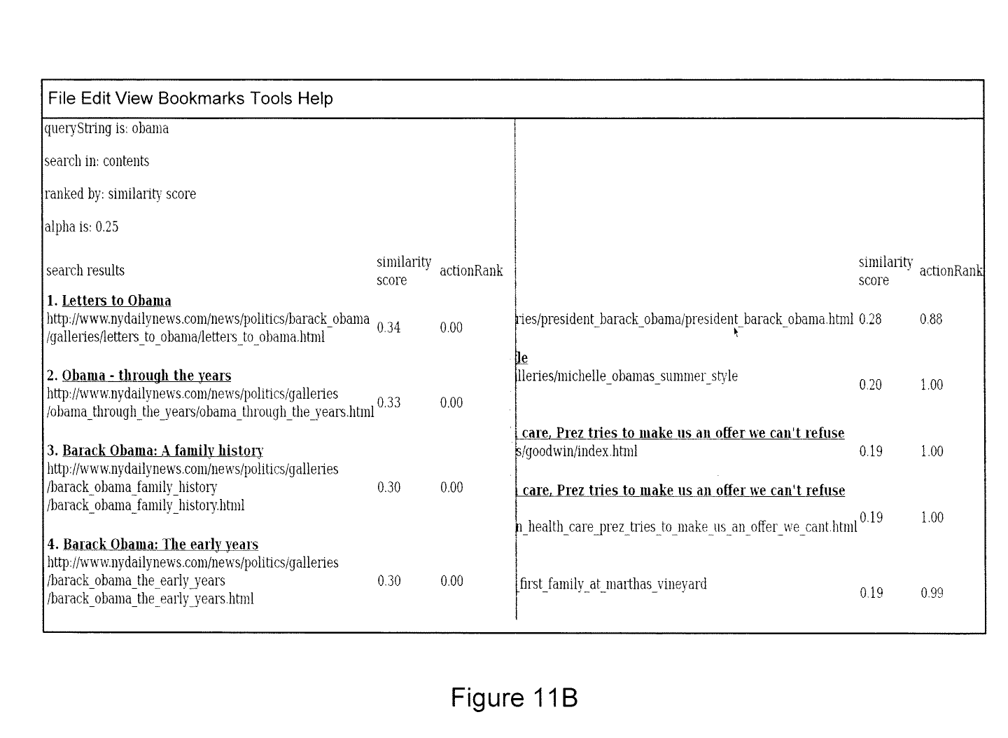

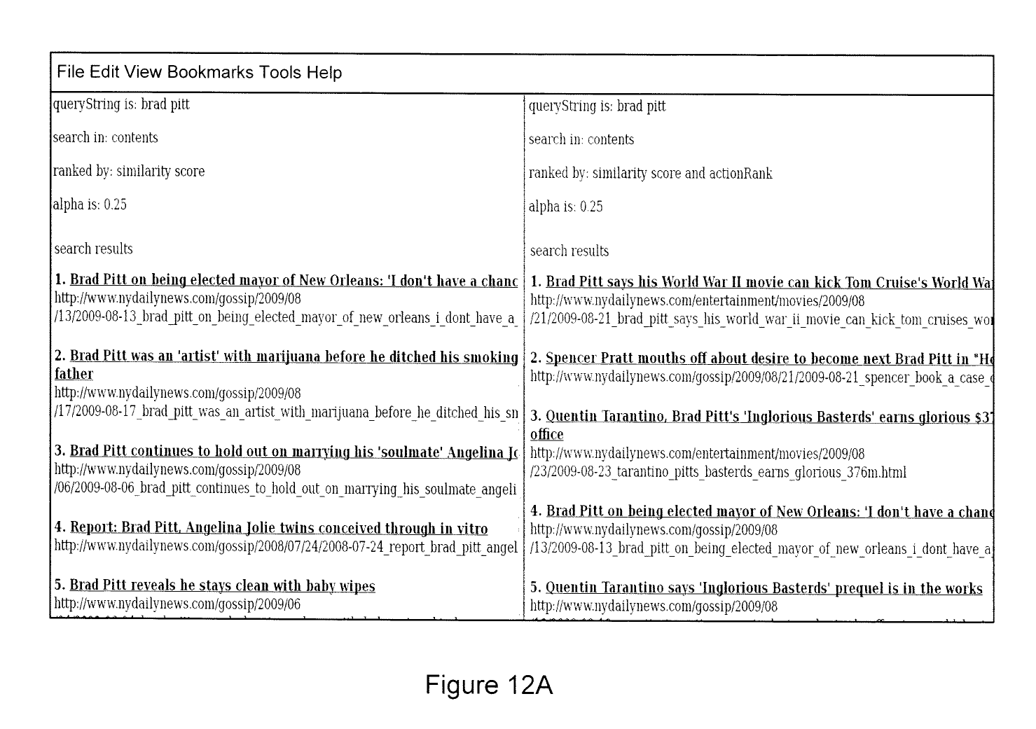

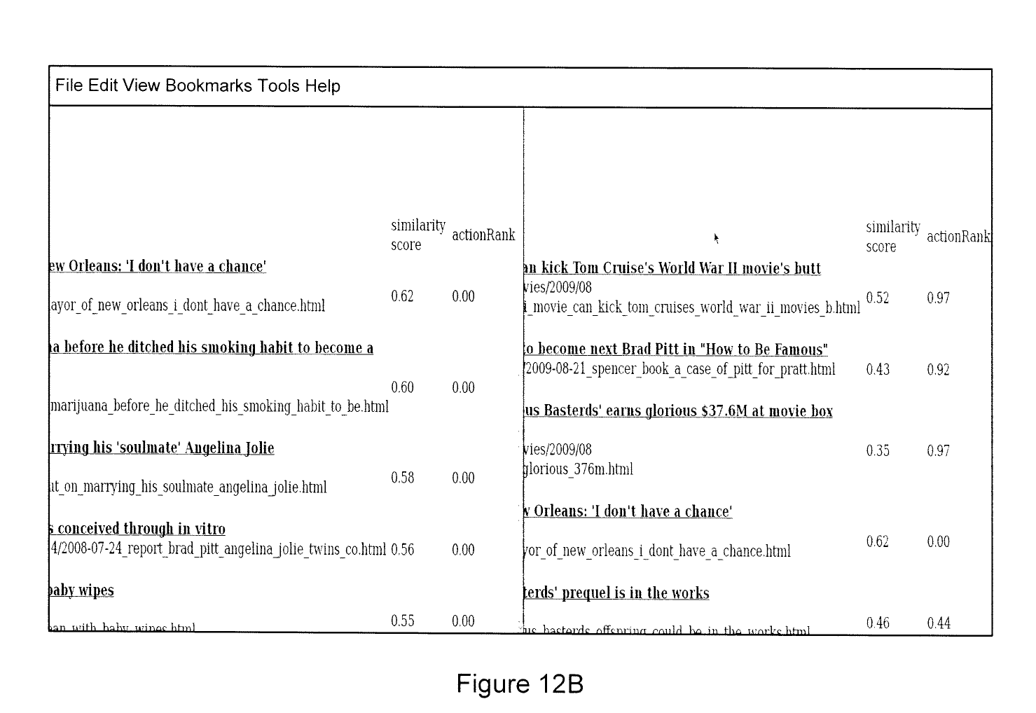

FIGS. 10, 11A-11B and 12A-12B show screenshots presented in the example. FIG. 10 is an entry point that receives search parameters, while FIGS. 11A-11B and FIGS. 12A-12B display results for specific searches.

FIGS. 11A-11B show search results for query “obama” ranked by CSS (left) and Action Rank (right). By searching “obama”, the user may seek recent news about the subject. The top pages given by CSS are related to Obama, but most of them are relatively old, because content-based searches only compare the contents of the web pages to the query (e.g. how many times the word “Obama” appear in a web page). This type of search cannot distinguish between new and old pages, and/or popular and forgotten pages. The top pages returned by Action Rank are related to Obama as well but are more recent, highly engaged and relevant, as identified by their Action Ranks.

FIGS. 12A-12B show search results for query “brad pitt” ranked by CSS (left) and Action Rank (right). The top CSS results for the search query “brad pitt” yields related pages that are no longer popular (low Action Ranks). In other words, these pages are not viewed, selected or copied much. Results returned by Action Rank are more recent. The top results are related to the movie “Inglorious Basterds”, released in August 2009 (recall that the web pages are collected on Aug. 25, 2009).

Consequently, the quality of search results is improved by taking user engagement into consideration, especially in those contexts where contents age fast (e.g. news websites). In certain embodiments, calculations can be purely based on user voting, rendering it difficult to manipulate the results. Moreover, the calculations can be easily made because they do not rely on contents or link structures, thereby requiring minimal computation.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for processing user interactions with content obtained from a network. In certain embodiments, the method is performed by one or more processors communicatively coupled to the network. Certain of these embodiments comprise detecting an implicit user interaction with an element of the content on a device that displays the content. In certain embodiments, the implicit user interaction includes at least one of a mouse over interaction with the element and a selection of the element. Certain of these embodiments comprise extracting at least one search term from the element. In certain embodiments, the at least one search term comprises a plurality of words extracted from the element. In certain embodiments, there are fewer than eight words in the plurality of words. Certain of these embodiments comprise automatically causing a search to be performed using the at least one search term. Certain of these embodiments comprise displaying one or more selected links on the display device. In certain embodiments, the one or more links are selected based on the at least one search term. In certain embodiments, the one or more selected links includes at least one result of the search.

In certain embodiments, the one or more links are displayed simultaneously with the content. In certain embodiments, the one or more links are displayed in a pop-up window on the display device. In certain embodiments, causing a search to be performed comprises providing the at least one search term to a search engine and receiving results from the search engine. In certain embodiments, the results are prioritized based on a history of implicit interactions with the element. In certain embodiments, a relevance of the element is calculated based on a history of implicit interactions with the element. In certain embodiments, the results are prioritized based on the relevance of the element. In certain embodiments, the method is performed by an agent received with the content. In certain embodiments, the element comprises fewer than eight words. In certain embodiments, the implicit user interaction includes copying the fewer than eight words.

Certain embodiments of the invention provide an agent adapted for use in conjunction with a browser on a computer system. In certain embodiments, the agent comprises data and instructions for execution by a processor of the computer. In certain embodiments, the data and instructions cause the computer to detect an implicit user interaction with an element of content displayed by the browser. In certain embodiments, the implicit user interaction includes at least one of a mouse over interaction, a copying interaction and a selection interaction. In certain embodiments, the data and instructions cause the computer to extract a search term comprising between 1 and 7 words included in the element. In certain embodiments, the data and instructions cause the computer to automatically cause a search to be performed using the search term. In certain embodiments, the data and instructions cause the computer to display one or more selected links including at least one result of the search. In certain embodiments, the one or more links are selected using the search term.

In certain embodiments, the instructions, when executed by a processor of the computer, further cause the computer to display the one or more selected links simultaneously with the content. In certain embodiments, the one or more links are superimposed on the content displayed by the browser. In certain embodiments, the instructions, when executed by a processor of the computer, cause the computer to extract a plurality of search terms from the one or more words included in the element, wherein the search identifies additional content based on the plurality of search terms. In certain embodiments, the results of the search are prioritized based on a history of implicit user interactions with the element. In certain embodiments, a relevance of the element is calculated based on a history of implicit interactions with the element by one or more users. In certain embodiments, the results are prioritized based on the relevance of the element. In certain embodiments, the agent is transmitted to the computer system with content accessed by the browser.

Certain embodiments of the invention provide systems and methods for capturing implicit user interactions with content displayed in a browser. Certain of these embodiments comprise communicating an agent to the browser. In certain embodiments, the agent includes data and instructions for execution by a processor of a computer system or computing device. In certain embodiments, the data and instructions cause the processor to detect an implicit user interaction with an element of content displayed by the browser. In certain embodiments, the implicit user interaction includes at least one of a mouse over interaction with words included in the element, a selection of words included in the element and a copying of words included in the element. In certain embodiments, the data and instructions cause the processor to extract a search term from the words included in the element. In certain embodiments, the data and instructions cause the processor to automatically initiate a search using the search term. In certain embodiments, the data and instructions cause the processor to display one or more selected links including at least one result of the search. In certain embodiments, the one or more links are selected using the search term. In certain embodiments, the words included in the element comprise up to seven words.

In certain embodiments, the instructions, when executed by a processor of the computer, cause the computer to display the one or more selected links simultaneously with the content superimposed on the content displayed by the browser. In certain embodiments, the instructions, when executed by a processor of the computer, cause the computer to extract a plurality of search terms from the element. In certain embodiments, the search identifies additional content based on the plurality of search terms. In certain embodiments, the results of the search are prioritized based on a history of implicit user interactions with the element.

Certain embodiments of the invention provide systems and methods for processing user interactions with content obtained from a network. In some of these embodiments, the method is performed by one or more processors communicatively coupled to the network. In some of these embodiments, the method comprises detecting an implicit user interaction with an element of the content on a device that displays the content. In some of these embodiments, the implicit user interaction includes a mouse over interaction with the element (using a mouse or other oral or tactile pointing device to place a mouse over the element) and/or selecting the element by command or menu option. In some of these embodiments, the method comprises extracting at least one search term from the element. In some of these embodiments, the method comprises displaying one or more selected links on the display device. In some of these embodiments, the one or more links are selected based on the at least one search term.

In some of these embodiments, one or more links are displayed simultaneously with the content. In some of these embodiments, the one or more links are displayed in a pop-up window on the display device. In some of these embodiments, the at least one search term comprises a plurality of search terms. In some of these embodiments, the one or more links include results of a search based on the search terms. In some of these embodiments, the results are prioritized based on a history of implicit interactions with the element. In some of these embodiments, a relevance of the element is calculated based on a history of implicit interactions with the element. In some of these embodiments, the results are prioritized based on the relevance of the element. In some of these embodiments, the method comprises the step of performing a search using the at least one search term. In some of these embodiments, the one or more selected links includes at least one result of the search. In some of these embodiments, the implicit user interaction includes copying the element. In some of these embodiments, the implicit user interaction includes printing and/or sharing the element.

Certain embodiments of the invention provide an agent adapted for use in a browser installed and/or executed on a computer system. In some of these embodiments, the agent comprises data and instructions that, when executed by a processor of the computer, cause the computer to detect an implicit user interaction with an element of content displayed by the browser. In some of these embodiments, the implicit user interaction includes a mouse over interaction with the element and/or a selection of the element. In some of these embodiments, the agent comprises data and instructions that, when executed by a processor of the computer, cause the computer to extract a search term from the element. In some of these embodiments, the agent comprises data and instructions that, when executed by a processor of the computer, cause the computer to display one or more selected links using the browser. In some of these embodiments, the one or more links are selected using the search term.

In some of these embodiments, the agent comprises data and instructions that, when executed by a processor of the computer, cause the computer to display the one or more selected links simultaneously with the content. In some of these embodiments, the one or more links are superimposed on the content displayed by the browser. In some of these embodiments, the agent comprises data and instructions that, when executed by a processor of the computer, cause the computer to extract a plurality of search terms from the element. In some of these embodiments, the agent comprises data and instructions that, when executed by a processor of the computer, cause the computer to initiate a search for additional content based on the plurality of search terms. In some of these embodiments, the one or more links include results of the search. In some of these embodiments, the results of the search are prioritized based on a history of implicit user interactions with the element. In some of these embodiments, a relevance of the element is calculated based on a history of implicit interactions with the element by one or more users. In some of these embodiments, the results are prioritized based on the relevance of the element. In some of these embodiments, the implicit user interaction includes copying of the element.

Certain embodiments of the invention provide systems and methods for capturing implicit user interactions with content displayed in a browser. Some of these embodiments comprise communicating an agent to the browser. In some of these embodiments, the agent includes data and instructions that, when executed by a processor that hosts the browser, cause the processor to detect an implicit user interaction with an element of content displayed by the browser. In some of these embodiments, the implicit user interaction includes mouse over interaction with the element, selection of the element and/or copying of the element. In some of these embodiments, the agent includes data and instructions that, when executed by a processor that hosts the browser, cause the processor to extract a search term from the element. In some of these embodiments, the agent includes data and instructions that, when executed by a processor that hosts the browser, cause the processor to display one or more selected links using the browser. In some of these embodiments, the one or more links are selected using the search term. In some of these embodiments, the agent includes data and instructions that, when executed by a processor that hosts the browser, cause the processor to display the one or more selected links simultaneously with the content superimposed on the content displayed by the browser. In some of these embodiments, the agent includes data and instructions that, when executed by a processor that hosts the browser, cause the processor to extract a plurality of search terms from the element. In some of these embodiments, the agent includes data and instructions that, when executed by a processor that hosts the browser, cause the processor to initiate a search for additional content based on the plurality of search terms. In some of these embodiments, the one or more links include results of the search. In some of these embodiments, the results of the search are prioritized based on a history of implicit user interactions with the element.

In some of these embodiments, an element may include text and/or graphics. Detection of interactions may be limited to elements having a minimum and/or maximum size, including text size measured in words and/or characters. In certain embodiments of the invention, the agent is transmitted to a computer system or to another type of processing device that can host a browser or can otherwise display network content. In some of these embodiments, the agent is transmitted as an attachment to and/or embedded in content accessed by the browser.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense and the invention is to be considered limited solely by the scope of the appended claims.

1: A method of processing user interactions with content obtained from a network, the method being performed by one or more processors communicatively coupled to the network, the method comprising:
detecting an implicit user interaction with an element of the content on a device that displays the content, the implicit user interaction including at least one of a mouse over implicit interaction with the element and a selection of implicit interaction with the element;
extracting at least one search term from the element, wherein the at least one search term comprises a plurality of words extracted from the element, and wherein there are fewer than eight words in the plurality of words;
automatically causing a search to be performed using the at least one search term; and
displaying one or more selected links on the display device, wherein the one or more links are selected based on the at least one search term, and
wherein the one or more selected links includes at least one result of the search.

2: The method of claim 1, wherein the one or more links are displayed simultaneously with the content.

3: The method of claim 2, wherein the one or more links are displayed in a pop-up window on the display device.

4: The method of claim 1, wherein causing a search to be performed comprises providing the at least one search term to a search engine and receiving results from the search engine.

5: The method of claim 4, wherein the results are prioritized based on a history of implicit interactions with the element.

6: The method of claim 4, wherein a relevance of the element is calculated based on a history of implicit interactions with the element.

7: The method of claim 6, wherein the results are prioritized based on the relevance of the element.

8: The method of claim 4, wherein the method is performed by an agent received with the content.

9: The method of claim 1, wherein the element comprises fewer than eight words and wherein the implicit user interaction includes copying the fewer than eight words.

10: An agent adapted for use in conjunction with a browser on a computer, the agent comprising data and instructions that, when stored in the memory of the computer and subsequently executed by a processor of the computer, cause the computer to:
detect an implicit user interaction with an element of content displayed by the browser, the implicit user interaction including at least one of a mouse over implicit interaction, a copying implicit interaction and a selection implicit interaction;
extract a search term comprising between 1 and 7 words included in the element;
automatically cause a search to be performed using the search term; and
display one or more selected links including at least one result of the search, wherein the one or more links are selected using the search term.

11: The agent of claim 10, wherein the instructions, when executed by a processor of the computer, further cause the computer to display the one or more selected links simultaneously with the content.

12: The agent of claim 11, wherein the one or more links are superimposed on the content displayed by the browser.

13: The agent of claim 10, wherein the instructions, when executed by a processor of the computer, cause the computer to extract a plurality of search terms from the one or more words included in the element, wherein the search identifies additional content based on the plurality of search terms.

14: The agent of claim 10, wherein the results of the search are prioritized based on a history of implicit user interactions with the element.

15: The agent of claim 10, wherein a relevance of the element is calculated based on a history of implicit interactions with the element by one or more users.

16: The agent of claim 15, wherein the results are prioritized based on the relevance of the element.

17: The agent of claim 10, wherein the agent is transmitted to the computer with content accessed by the browser.

18: A method of capturing implicit user interactions with content displayed in a browser, comprising communicating an agent to the browser, wherein the agent includes data and instructions that, when executed by a processor that hosts the browser, cause the processor to:
detect an implicit user interaction with an element of content displayed by the browser, the implicit user interaction including at least one of a mouse over of words included in the element, a selection of words included in the element and a copying of words included in the element;
extract a search term from the words included in the element;
automatically initiate a search using the search term; and
display one or more selected links including at least one result of the search, wherein the one or more links are selected using the search term, and wherein the words included in the element comprise up to seven words.

19: The method of claim 18, wherein the instructions, when executed by a processor of the computer, cause the computer to display the one or more selected links simultaneously with the content superimposed on the content displayed by the browser.

20: The method of claim 18, wherein the instructions, when executed by a processor of the computer, cause the computer to extract a plurality of search terms from the element, wherein the search identifies additional content based on the plurality of search terms, and wherein the results of the search are prioritized based on a history of implicit user interactions with the element.
